(19) United States
(12) Patent Application Publication
(10) Pub. No.: US 2024/0246246 A1
(43) Pub. Date: Jul. 25, 2024

(54) Adaptive Gripper for Robotics and Other Applications

(71) Applicant: Harvest Moon Automation Inc., Winchester, MA (US)

(72) Inventors: Stephen C. Jens, Winchester, MA (US); Janice Huxley Jens, Winchester, MA (US)

(21) Appl. No.: 18/416,541

(22) Filed: Jan. 18, 2024

Related U.S. Application Data
(60) Provisional application No. 63/480,816, filed on Jan. 20, 2023.
(60) Provisional application No. 63/499,021, filed on Apr. 28, 2023.

(51) Int. Cl. B25J 15/12; B25J 13/02

(52) U.S. Cl. CPC B25J 15/12; B25J 13/025

(57) ABSTRACT

An end effector including a first deformable element having a proximal end and a distal end, and a second deformable element having a proximal end and a distal end. The first and second deformable elements can be mechanically coupled at the respective distal ends. At least one movable member can mechanically interact with and increase structural strength of at least one of the first and second deformable elements between the respective proximal ends and distal ends upon actuation of at least one of the first and second deformable elements. The first and second deformable elements can each have an area moment of inertia that enables cooperative operation of tension and compression. An actuating arrangement can be included to which at least one of the first and second deformable elements can be coupled at the respective proximal end.

### RELATED APPLICATION(S)

This application claims the benefit of U.S. Provisional Application No. 63/480,816, filed on Jan. 20, 2023 and also claims the benefit of U.S. Provisional Application No. 63/499,021, filed on Apr. 28, 2023. The entire teachings of the above application(s) are incorporated herein by reference.

### BACKGROUND

The demand for robotics in industrial, commercial, defense, and consumer settings has increased significantly in recent years. There have been many technology advances, such as collaborative robots that can work safely alongside humans, and mobile robots that can change position and navigate obstacles within an environment. Robots are also increasingly moving from single task to multi-task systems and from highly controlled environments to less controlled environments. These trends and others are driving a need for more flexible and gentle grippers that can perform a wider range of tasks on a wider range of objects than were needed in the past.

Current robotic grippers are typically either strong but can damage the target object, or soft and flexible but have low grasping force. For example, rigid grippers with fingers that are designed with multiple joints are often used to pick up and move an object with precision. They do not evenly wrap fingers around the object, so the loads on the object can have high point loads. This is a problem with items such as fragile fruit and vegetables, which can be damaged. It can also be a problem with round connectors that require a high torque load or pull force to engage or disconnect. Depending upon the friction between the connector and the rigid gripper, a large load may need to be exerted to rotate or move the connector. Soft compliant grippers are typically molded from a flexible silicone or urethane-like material that wraps around an object when air pressure is applied to the fingers. However, the fingers remain flexible when inflated, and do not exhibit rigid stiffness, thereby causing a low grasping force.

### SUMMARY

The present disclosure can provide an end effector including a first deformable element having a proximal end and a distal end, and a second deformable element having a proximal end and a distal end. The first and second deformable elements can be mechanically coupled at the respective distal ends. At least one movable member can mechanically interact with and increase structural strength of at least one of the first and second deformable elements between the respective proximal ends and distal ends upon actuation of at least one of the first and second deformable elements. The first and second deformable elements can each have an area moment of inertia that enables cooperative operation of tension and compression. An actuating arrangement can be included to which at least one of the first and second deformable elements can be coupled at the respective proximal end.

In particular embodiments, at least one of the first and second deformable elements can be normally straight flexible spring members. In some embodiments, the end effector can be a gripper. The first and second deformable elements and the at least one movable member can be included in a first finger of the gripper. The gripper can further include at least a second finger that has at least a second set of the first and second deformable elements and the at least one moveable member, for gripping an object between the first finger and the at least a second finger. The at least one movable member can be at least one of a constraining member, chain, link, tube, coil spring, ring, glove and rib. The at least one movable member can constrain separation distance between the first and second deformable elements. In one embodiment, the at least one movable member can include at least one constraining member encircling the first and second deformable elements. In another embodiment, the at least one movable member can include at least one connecting member extending between the first and second deformable elements. In some embodiments, the at least one of the first and second deformable elements can be a flat band having a rectangular cross-section. At least one of the first and second deformable elements can be a band formed of at least one of spring steel, aluminum, metal, polymer, textile and composites. In some embodiments, at least one of the deformable elements can include at least one hinge between the proximal and the distal ends. In some embodiments, the first and second deformable elements can range from about ¼ inch to 6 inches wide, about 1 inch to 3 feet long, and about 0.010-0.030 inches thick. The actuation arrangement can include at least one actuator connected to at least one of the first and second deformable elements, for at least one of retracting and extending the first and second deformable elements relative to each other to bend the first and second deformable elements and cause the first and second deformable elements to mechanically interact with the at least one movable member and form a truss like structure. The first finger and the at least a second finger can be each connected to a respective first and at least a second actuator. The first and the at least a second actuator for at least one of retracting and extending the first and second deformable elements of the first finger and of the at least a second finger relative to each other to bend the respective first and second deformable elements and cause the respective first and second deformable elements to mechanically interact with the respective at least one movable member to form a respective truss like structure and increase gripping strength between the first finger and the at least a second finger. In some embodiments, at least one finger can be arranged to serve as an opposable thumb of at least one of a robotic hand, an exoskeleton hand or glove, and a prosthetic hand. A robotic arm can be included and the gripper can be mounted to the robotic arm. A controller can control at least one of the gripper and the robotic arm. A sensor arrangement can be incorporated into the first finger and the at least a second finger for sensing at least one of bending, position, and force effects of a respective finger. The gripper can be controlled by a haptic interface that can include a haptic glove for insertion of a user's hand. The end effector and the robotic arm can form a robot.

The present disclosure can also provide an end effector including a first deformable element having a proximal end and a distal end, and a second deformable element having a proximal end and a distal end. The first and second deformable elements can be mechanically coupled at the respective distal ends. At least one constraining member can mechanically constrain separation distance between the first and second deformable elements between the respective proximal ends and distal ends. The first and second deformable elements can each have an area moment of inertia that enables cooperative operation of tension and compression. An actuating arrangement can be included to which at least one of the first and second deformable elements can be coupled at the respective proximal end for at least one of retracting and extending the first and second deformable elements relative to each other, to bend the first and second deformable elements and cause the first and second deformable elements to mechanically interact with the at least one constraining member to form a truss like structure.

The present disclosure can also provide a method of operating an end effector including providing a first deformable element having a proximal end and a distal end, and a second deformable element having a proximal end and a distal end. The first and second deformable elements can be mechanically coupled at the respective distal ends. At least one movable member can mechanically interact with and increase structural strength of least one of the first and second deformable elements between the respective proximal ends and distal ends upon actuation of least one of the first and second deformable elements. The first and second deformable elements can each have an area moment of inertia that enables cooperative operation of tension and compression. An actuating arrangement can be coupled to at least one of the first and second deformable elements at the respective proximal end. At least one of the first and second deformable elements can be actuated with the actuating arrangement to at least one of retract and extend the first and second deformable elements relative to each other, to bend the first and second deformable elements.

In particular embodiments, at least one of the first and second deformable elements can be normally straight flexible spring members. The end effector can be a gripper. The first and second deformable elements and at least one movable member can be included in a first finger of the gripper. The gripper can further include at least a second finger that has at least a second set of the first and second deformable elements and the at least one moveable member, for gripping an object between the first finger and the at least a second finger. The at least one movable member can be at least one of a constraining member, chain, link, tube, coil spring, ring, glove and rib. The movable member can constrain separation distance between the first and second deformable elements and form a truss like structure, increasing gripping strength between the first finger and the at least a second finger. Objects can be gripped between the first finger and the at least a second finger, and further at least one of retracting and extending the first and second deformable elements of the first finger and the at least a second finger relative to each other, can cause the first finger and the at least a second finger to bend around a portion of the object. The degree of curvature between a contact point of each finger on the object and the distal end of each finger can be greater than degree of curvature between the proximal end of each finger and the respective contact point on the object. The gripper can be mounted to and operated with a robotic arm. At least one of the gripper and the robotic arm can be controlled with a controller. At least one of bending, position and force effects of each finger can be sensed with a sensor arrangement incorporated into the first finger and the at least a second finger. The gripper can be controlled in some embodiments with a haptic interface including a haptic glove into which a user's hand can be inserted. The first finger and the at least a second finger can each be connected to a respective first and at least a second actuator.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a table listing industry sectors and use applications for embodiments in the present disclosure.

FIG. 2A is a machine vision raw image of strawberry plants before mapping, and FIG. 2B is a machine vision image mapping of ripe strawberries.

FIG. 3 is a schematic drawing of an embodiment of a gripper with fingers relaxed around a strawberry, and with fingers actuated to grip the strawberry.

FIG. 4 side view of an embodiment of a single finger grabbing a roll of tape.

FIG. 5 is a schematic view of an embodiment of a gripper grasping a strawberry.

FIG. 6 is side view of a portion of an embodiment of a gripper with a flexible finger being bent.

FIG. 7 is a perspective schematic drawing of a portion of an embodiment of a finger.

FIGS. 8A and 8B are perspective schematic drawings of a portion of other embodiments of a finger.

FIG. 9 is a perspective schematic drawing of a portion of another embodiment of a finger.

FIG. 10 is a perspective schematic drawing of a portion of another embodiment of a finger.

FIG. 11A is perspective view of an embodiment of a gripper gripping a light bulb, and FIG. 11B is a perspective view of a gripper grasping a 20 pound dumbbell weight.

FIG. 12A is a perspective view of a portion of an embodiment of a finger module, and FIG. 12B is a perspective view showing the finger being actuated and flexed.

FIG. 13 is perspective view of an embodiment of a gripper having two fingers.

FIG. 14A is a perspective view of an embodiment of a gripper having five fingers, and FIGS. 14B and 14C are perspective views of the gripper grasping a cup.

FIG. 15A is a schematic drawing of a portion of an embodiment of a pair of deformable strips for a finger, and FIG. 15B is a plan view of an embodiment of a sensor.

FIG. 16 is a schematic drawing of an embodiment of a gripper in a haptic feedback arrangement.

FIG. 17 is a perspective schematic drawing of a portion of an embodiment of a finger having a jointed strip.

FIGS. 18A and 18B are side and perspective schematic views of another embodiment of a portion of a finger, and showing the finger in relaxed and opposite direction actuated positions.

FIGS. 19A and 19B are side and perspective schematic views of a portion of another embodiment of a finger showing the finger in opposite direction actuated positions.

FIGS. 20A and 20B are side and perspective schematic drawings of a portion of another embodiment of a finger showing the finger in two positions.

FIG. 21 is a side perspective view of a robot having an embodiment of a gripper in the present disclosure.

FIGS. 22 and 23 are side and perspective schematic views of the gripper of FIG. 21.

FIGS. 24 and 25 are side and perspective schematic views of an embodiment of a finger module of the gripper of FIGS. 22 and 23.

FIG. 26 is a perspective view of an embodiment of an actuator arrangement for a finger module.

FIGS. 27 and 28 are side and perspective schematic views of the finger module actuating and bending the finger.

FIGS. 29 and 30 are side and perspective schematic views of the gripper of FIG. 21 with the fingers bent inwardly.

FIGS. 31 and 32 are side and perspective schematic views of the finger module actuating and bending the finger in the opposite direction to that in FIGS. 27 and 28.

FIGS. 33 and 34 are side and perspective schematic views of the gripper of FIG. 21 with the fingers bent outwardly.

FIG. 35 is a side perspective view of the of the robot of FIG. 21 gripping an object with the gripper.

FIGS. 36 and 37 are side and perspective schematic views of the gripper in FIG. 35 gripping the object.

FIG. 38 is a schematic drawing of two fingers in cross-section gripping the object.

FIGS. 39 and 40 are side and perspective schematic views of an embodiment of a finger module with the finger shown in relaxed and opposite actuated positions.

### DETAILED DESCRIPTION

A description of example embodiments follows.

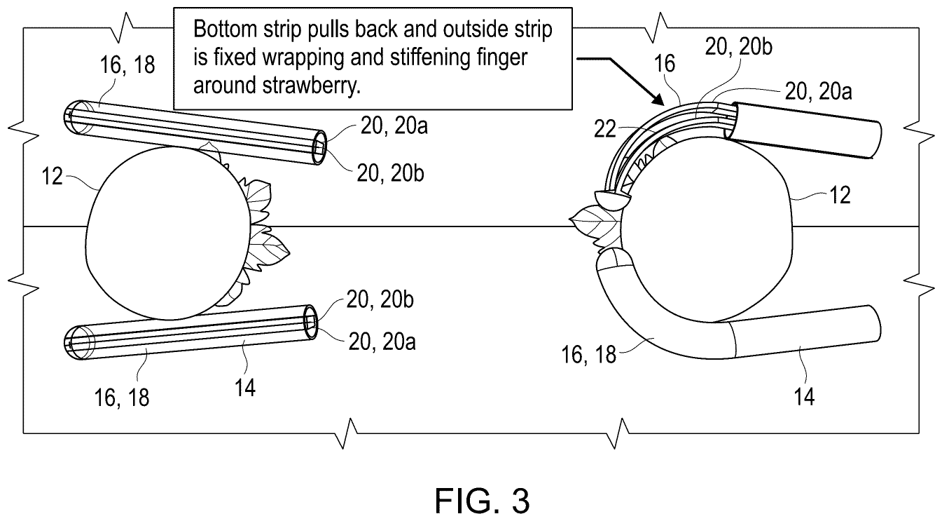

The present disclosure can provide an apparatus and method for mechanically holding, gripping, grasping or grabbing an object, and adapting to its profile so that the object can be manipulated without damage. Example embodiments of a gripping apparatus in the present disclosure can be referred to herein as a “gripper”, an “adaptive gripper” or an “adaptive robotic gripper.” Some objects that are fragile, for example fruit such as strawberries, are often picked by human hand to avoid damage. However, embodiments of an adaptive gripper 14 in the present disclosure can grip, handle and pick fragile fruit including strawberries without damage, as shown in FIGS. 3 and 5. Additional description of FIGS. 3 and 5 is provided further below. Gripper 14 is also suitable for gripping a variety of other objects in a variety of different uses. The adaptive gripper has a unique structure and can conform to the object such that the grasping force in some embodiments, can uniformly spread under the gripper fingers, thereby avoiding high pressure points that can damage the object. Anthropomorphic prior art robotic grippers are designed to emulate the human hand but have challenges with high mechanical and control complexity in handling a variety of objects and fragile objects. The adaptive gripper can simplify the control since the adaptive gripper can mechanically adjust to the profile of the object. The control complexity of operating the gripper can be reduced by morphological computation of the adaptive gripper's unique mechanical design that adapts to the profile of the object. The adaptive gripper can grasp and handle objects that vary in size, shape, weight, and fragility. The adaptive gripper can provide a unique combination of features and capabilities including but not limited to: (1) high grasping strength, (2) gentle grasp, (3) slender profile for use in tight or dense spaces, (4) modular design—can incorporate one or more fingers for grasping, (5) scalable in size, (6) reliable, (7) low cost, (8) adjustable operating speed, and (9) case of control. The adaptive gripper can be actuated in various ways, including manual, electrical, or pneumatic, and can be interfaced with a robotic arm or used independently. It can be operated in harsh or dirty environments as well as clean environments, such as food processing facilities. The adaptive gripper can be used for many applications across a broad range of industry sectors. Applications include, but are not limited to: (1) harvesting/handling fragile produce and food; (2) pick and place operations in warehouse fulfillment centers; (3) autonomous or remote-controlled robots that perform a variety of tasks in indoor/outdoor environments, including harsh or dangerous environments such as nuclear power plants, defense environments, underwater, and space; and (4) exoskeletons for physical therapy, assisting human labor, and (5) prostheses.

An example embodiment of the adaptive gripper can exhibit dual properties of being extremely flexible and compliant when it engages an object and then, upon activation, the adaptive gripper can become very rigid and strong so that the object can be grasped and manipulated. The adaptive gripper is capable of gently grasping an object such as a strawberry and then firmly gripping the strawberry so that it can be snapped from its stem and removed. The adaptive gripper can be configured with an unlimited number of fingers, including the most common configurations of a two, three, or a five-finger gripper that resembles a human hand. The fingers can be flexible and easily conform to the object that they are engaging and, upon activation (also referred to as “actuation” herein), become rigid so that the object can be grabbed and moved, similar to how human fingers function. Tasks such as grabbing and holding objects, handling fragile produce, opening latches, and plugging and unplugging connectors can be done by a robot with a gripper having this adaptive grabbing and grasping capability.

Embodiments of the adaptive gripper can have narrow and flexible fingers that allow it to be easily maneuvered around obstacles. In operation, the fingers can be adjusted to form a narrow profile, much like the fingers on a human hand so that the adaptive gripper can be maneuvered in tight spaces and not accidentally snag a nearby wire or tube. Once the gripper is near the object to be grabbed, the fingers can be adjusted again so that the individual fingers wrap around the object. After the gripper is in position relative to the object, the gripper fingers may be actuated and rigidly grasp the object, allowing a robot employing the adaptive robotic gripper to manipulate the object, such as rotate, lift, reposition, and/or push/pull the object.

An example advantage of the adaptive gripper is that it does not have to be precisely positioned to grab an object. Unlike a precision gripper with rigid fingers that moves through a defined profile, the adaptive gripper can have very flexible fingers. When actuated, the flexible fingers can conform to the profile of the object that is being grasped.

The adaptive gripper can be flexible in an initial (non-actuated) phase but then become rigid and strong in a second (actuated) phase. Thus, the adaptive gripper can exhibit advantages of both a soft pneumatic gripper and a precision rigid gripper.

Embodiments of the adaptive gripper has many applications. The adaptive gripper can grasp fragile items of irregular or variable shape, size, weight and fragility, and can operate in dense or small-space environments owing to its example unique design features, which can include: (1) human-like, thin-finger grip, (2) variable stiffness, (3) simple, low-cost design, (4) lightweight, and (5) reliable, and (6) compatible with harsh environments which have dust, large temperature variations, or radiation.

Food and agriculture is a leading market sector for robotic grippers for fragile items. A shortage of skilled labor coupled with rising wages is a key driver of demand for automating agricultural processes in the plant and in the field. Other drivers include enhanced food safety (reduced exposure to human pathogens); enhanced yield and harvested crop quality; and reduced waste (crops left in fields unharvested due to lack of labor).

The application of embodiments of the adaptive gripper in the manufacturing and industrial sector is attractive with one gripper able to handle many different tasks. In a prior art manufacturing cell, a robot typically has multiple grippers and end tools to accomplish a variety of tasks, such as opening doors and moving parts. A single gripper that accomplishes a variety of tasks can help improve work cell efficiency and throughput.

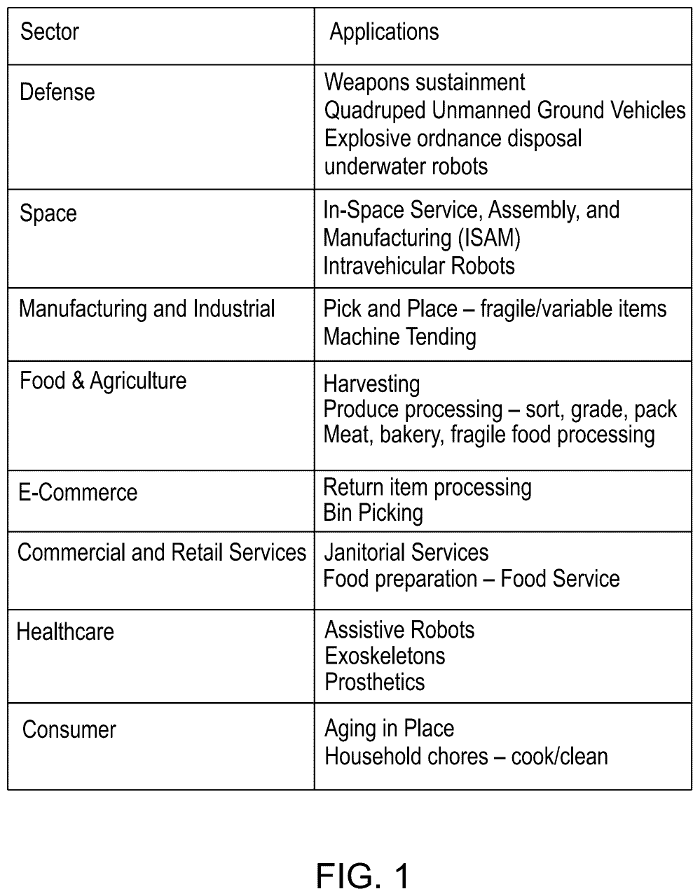

The adaptive gripper has many different applications across a wide range of sectors. FIG. 1 identifies many sectors and applications, but not necessarily all applications for the adaptive robotic gripper. The application set is inclusive of but not limited to these applications.

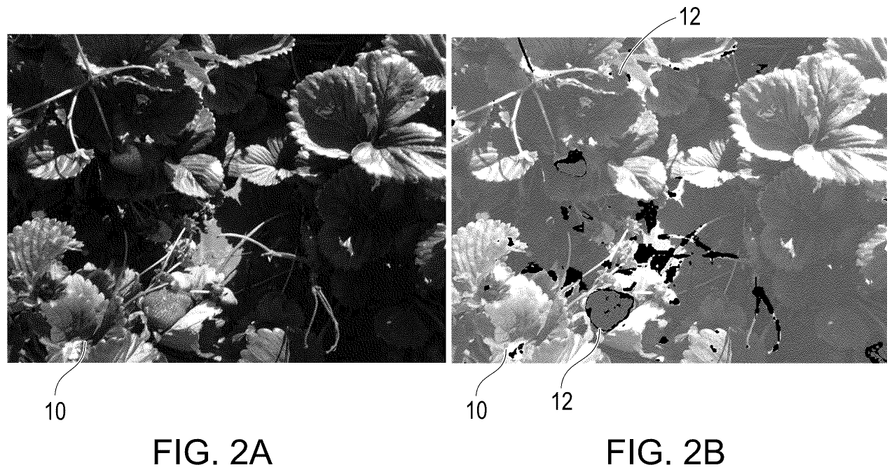

An example embodiment of an adaptive gripper enables a robot to perform fine grabbing and grasping tasks, such as picking/handling fragile produce, or performing maintenance tasks, such as plugging and unplugging connectors. An application in which the adaptive gripper is well suited is for picking/handling fragile produce such as strawberries. FIG. 2A shows strawberry plants 10 on a soil bed with fruit. The image is a raw color picture, and the image in FIG. 2B is a machine vision view that locates or maps the ripe and semi-ripe strawberries or fruit 12 on the plants 10. As shown in the images, the ripe strawberries 12 are typically intermingled among other strawberries, stems, and leaves. The adaptive gripper can grip the strawberry 12 without grabbing neighboring stems and leaves.

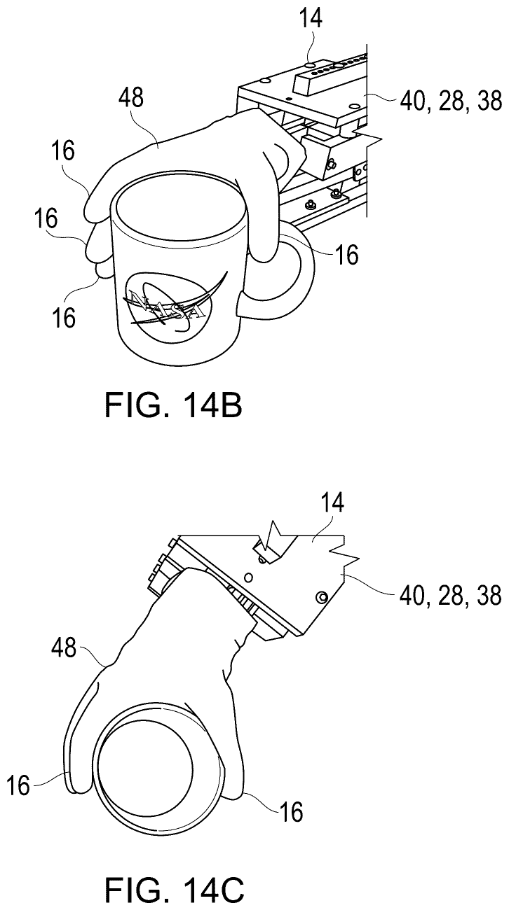

The adaptive gripper can be a two-phase gripper that is extremely flexible when engaging an object such as a strawberry 12, wrapping its fingers around the strawberry, then upon activation, becoming very rigid so that the strawberry 12 can be rotated and snapped from its stem. As shown in FIG. 3, an embodiment of an adaptive gripper 14 utilizes composite actuating members or fingers 16 including a compliant outside moveable or constraining member, cover, tube or material 18 with thin elongate flexible deformable spring elements, beams, members, bands, straps or strips 20 that can be made from many different materials, including spring steel strips, as an example, inside the finger 16. Spring steel strips 20 can be very flexible (in a relaxed non-actuated state shown at the left in FIG. 3) when they are resting next to each other during engagement with the strawberry 12. In the non-actuated state, the fingers 16 can easily flex around the strawberry 12. To make the fingers 16 rigid (in an actuated state shown at the right in FIG. 3), the moveable inside or inner spring steel strip 20b can be pulled back with an actuator while the outside or outer strip 20a is held fixed. When transitioning from the non-actuated to the actuated state, the outside strip 20a bows outward, forcing the inside strip 20b to wrap around the strawberry 12. A gap 22 is now created between the two spring steel strips 20 in the actuated state, with the outside strip 20a held in its bowed configuration. The shape can be like a truss, whereby the finger 16 can now be very stiff with the stiffness of the two spring steel strips 20 increasing dramatically with the gap 22 between them. The inside layer or strip 20b of the finger 16 is held wrapped around the strawberry 12 within the material 18 with the outside layer or strip 20a bowed out creating stiffness in the finger 16 so that the strawberry 12 can be rotated and snapped off the stem. The outside compliant layer 18 of the fingers 16 can be cast like a glove 48 (FIG. 14A), with the entire gripper 14 inside the glove 48, so that cleaning the gripper 14 can in some embodiments only involve replacing the glove 48.

The stiffness of the adaptive gripper 14 can be increased when the two spring steel strips 20 in the fingers 16 separate, enhancing the rigidity of the fingers 16. The increased stiffness is dramatic as explained by the parallel axis theorem for structures. When the steel strips 20 are next to each other in the relaxed phase (non-actuated state), they are very flexible, but when they are separated in a second phase (actuated state) by the movement of the inside steel strip 20b away from the outside strip 20a, they become very rigid. In the second phase, the two steel strips 20 can be separated by about 0.25 inches in this example. The parallel axis theorem can predict that the stiffness of a structure is proportional to the square of the separation distance. In this case, the stiffness of the finger 16 has increased significantly from what it was in the flexible state.

The compliant material 18 that comprises the outside layer of the finger 16 does not need to change properties in the transition from the first phase to the second phase of the gripper 14. The compliant material 18 can be many different materials, including polymers such as silicone rubber or a similar material that can be cast into a glove 48 with fingers that slide over the spring steel strips 20. The spring steel strips 20 can expand inside the fingers of the glove 48 and can wrap the fingers 16 around an object or relax to release it. The glove 48 serves several functions, including: (i) acting as compliant material 18 that contacts the object so that it is not damaged, (ii) controlling the maximum separation distance between the strips 20, and (iii) acting as a barrier.

The design of the fingers 16 can be a modular design, whereby each finger 16 can be a module with its own actuator and spring steel strips 20. The actuator can be a pneumatic cylinder, but if more precise control of the actuation load is needed, the actuator can be an electrical linear actuator. In this example embodiment, the fingers can be attached to a base with several different finger configurations available, such as two, three, or other multiple finger configurations that may be chosen depending upon the object to be grabbed.

An example unique advantage of the adaptive gripper 14 is that it is a simple design that is easy to position and activate. Unlike a precision gripper with rigid fingers that move through a defined path or profile, the adaptive gripper 14 can have very flexible fingers that do not have to move through a defined profile. When actuated, the flexible fingers 16 can conform to the profile of the object that they are grasping. Consequently, precise positioning of the adaptive gripper 14 relative to the object is not required. The robot simply maneuvers and positions the gripper 14 so that the flexible fingers 16 are positioned within a grabbing proximity to the object. The fingers 16 can wrap around the object when actuated, conforming to its profile.

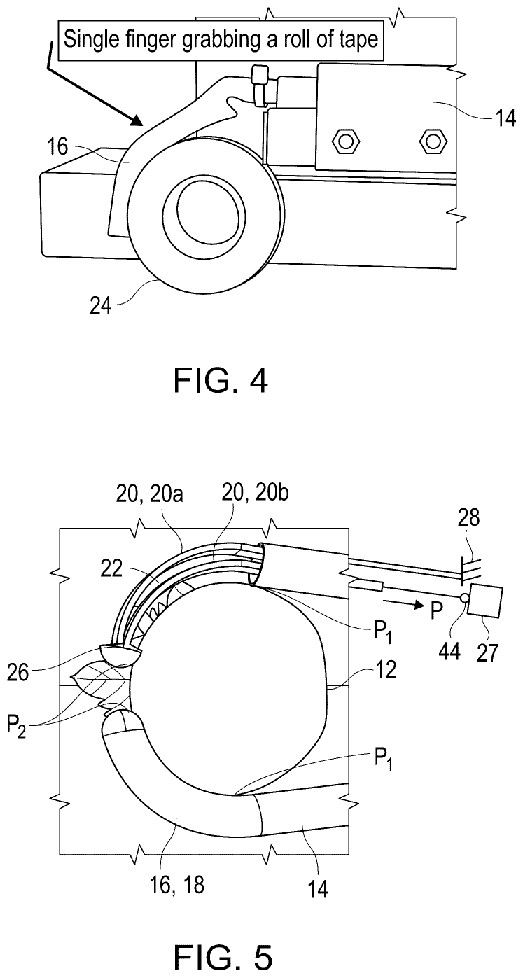

FIG. 4 shows an embodiment of an individual finger 16 wrapping around a roll of tape 24 after the individual finger 16 is actuated. A single finger 16 controlled by a single actuator can allow force to be changed depending upon the gripping force required.

Two-phased actuation of the adaptive gripper 14 can allow for a rigid grip on the object. Prior art soft pneumatic grippers on the market today are flexible and can conform to the profile of the object. However, prior art soft pneumatic grippers continue to remain pliable after they are pressurized to grab the object. The advantage of the adaptive gripper 14 described here is that it can be flexible in its initial phase but become rigid like a precision gripper with rigid fingers in the second phase. The actuation of the steel strips 20 in the individual fingers 16 can cause the steel strips 20 to form a rigid steel truss that behaves similar to a rigid fixed finger. However, unlike a gripper with rigid fingers, the adaptive gripper 14 can also conform to the object, wrapping each finger 16 around it and then becomes rigid in this configuration. The adaptive gripper 14 can exhibit advantages of both a soft gripper and a precision rigid gripper.

Embodiments of the adaptive gripper 14 can be actuated by a single strip 20 (spring steel strip in this example) that can handle a pull load of 400 lbs (for a 0.5-inch-wide finger 16) with minimal stretch. A one inch wide finger 16 with a corresponding width spring steel strip 20 can handle a pull load of 800 lbs. The use of the spring steel strip 20 to flex the finger greatly increases the grasping power of the gripper 14 compared to a prior art cable driven gripper. The actuation path for the strip 20 can be a simple path that minimizes parasitic losses due to friction. The simple design of the fingers 16 of the adaptive gripper 14 allows for larger forces to be achieved without the stretching and parasitic losses seen with prior art cable driven grippers.

The adaptive capability of the adaptive gripper 14 can allow for a single gripper 14 to be used for multiple tasks. The design of the gripper finger 16 can utilize first, outside or outer 20a, and second, inside or inner 20b members, elements, bands, straps or strips of material, and can be spring steel, as well as have a rectangular cross section. The inner strip 20b can be the same width as the outer strip 20a, but the inner strip 20b can be thinner than the outer strip 20a, which can give the inner strip 20b more compliance when it wraps around the object that it is grabbing. In this example, a two finger gripper 14 can have an outer strip 20a that can be 0.020 inches thick, and the inner strip 20b can be about 0.015 inches thick. The force required to bend the strips 20 can be a function of the thickness to the third power. Consequently, in this case the inner strip 20b can be over twice as compliant as the outer strip 20a. The inner strip 20b can allow the gripper finger 16 to conform to the object, while the stiffness of the combined structure of the outer 20a and inner strips 20b can allow for large forces to be developed in grasping the object.

The simple design of the adaptive gripper 14 can also allow it to be easily scaled to different sizes with different force and torque capabilities. The gripper size and capabilities can be easily changed to match the operating tasks. The adaptive gripper 14 can be constructed with a common base that powers the fingers 16, but the fingers 16 can be changed to match the load and size profile required. This can allow the robot to tackle multiple tasks, such as lifting heavy objects or picking up popcorn seeds.

An example embodiment of the adaptive gripper finger 16 in FIG. 5 includes an outside 20a and inside strip 20b. During actuation, their maximum outward movement relative to each other, or away from each other, is constrained, forcing the two strips 20 to bend and separate when the inside strip 20b is pulled back in the direction of arrow P by an actuator 27 coupled to the proximal end of the inside strip 20b. The actuator 27 can be a linear actuator, and in some embodiments can include a motor, pneumatic or hydraulic cylinder, or other suitable actuator. As the inside strip 20b is pulled back or rearwardly, it wraps around the object or strawberry 12 beginning at a first or proximal contact point P₁ and terminating at a second or distal contact point P₂, while the outside strip 20a separates from the inner strip 20b. The separation of the strips 20 can increase stiffness of the finger so that the strips 20 can rigidly grasp the object 12 while inside cover or material 18.

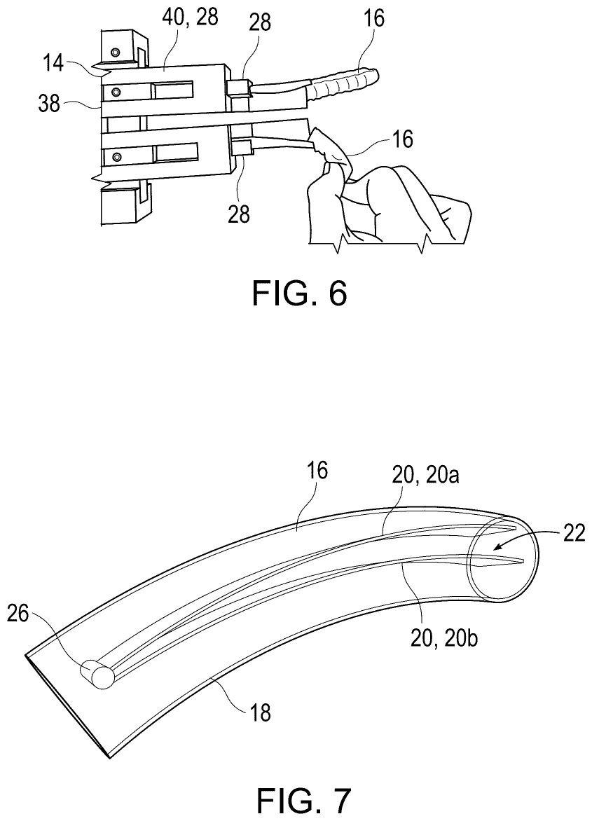

The distal ends of the strips 20 can be connected together at the distal end of the finger 16 at a joint, bracket, connection or coupling 26 that can be fixed or hinged. At the base or proximal end of the finger 16, the proximal end of the outside strip 20a can be fixed to a base 28, and the inside strip 20b is free to move or slide relative to the outside strip 20a. Pushing the inside strip 20b forward causes the finger 16 to flex upward, and pulling the inside strip 20b backward causes the finger 16 to flex downward. In the relaxed state, the strips 20 rest next to each other. In this relaxed state, the finger 16 is very flexible allowing it to be flexed easily, as shown in FIG. 6. One of the advantages of the adaptive gripper's 14 finger 16 flexibility is that it will easily flex around an object rather than puncture it and cause damage to the object. This is especially desirable for fragile objects like strawberries 12.

Referring to FIG. 7, in an example embodiment, the strips 20 can be surrounded by an outside moveable constraining member, material, cover or tube 18 that serves to control the maximum amount of separation of the strips 20 and also serves as an outside skin or barrier of the finger 16. If the separation of the strips 20 were not controlled, the strips 20 would continue to separate from each other and would not bend similar to a human finger. The outside tube 18 can limit the separation to a predetermined gap 22 as the inside strip 20b is pulled back. This constraint forces the two strips 20 to bend in a coordinated manner, causing the finger 16 to wrap around and grasp the object 12.

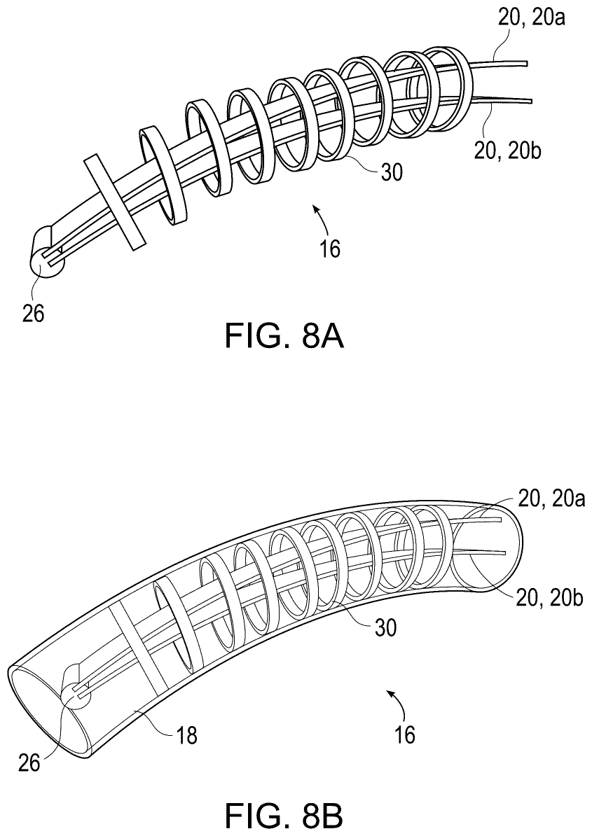

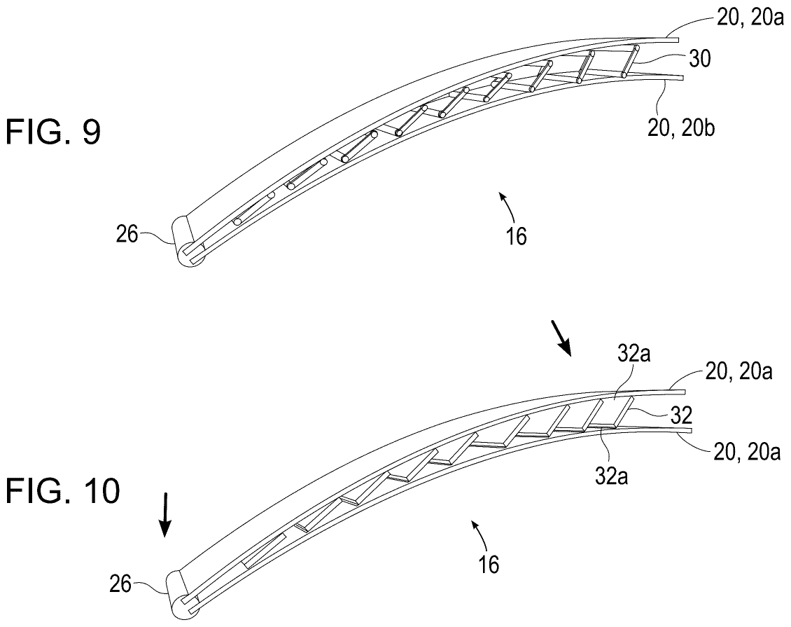

The outside cover or tube 18 surrounding the two strips 20 can be constructed from a number of different materials. It can be formed from a silicone or urethane material and molded like a glove. The outside tube 18 can alternatively be constructed from latex or rubber. A series of rings 30 made of steel, plastic, rubber, textiles, composites or other suitable material, separated from each other at a set distance along the finger 16, can also or alternatively be used to constrain the separation of the strips 20 (FIG. 8A). In a case of a combination of an outside tube 18 and rings 30 (FIG. 8B), the rings 30 can be molded and integrated into the outer tube 18 that surrounds the rings 30 and strips 20. The rings 30 may alternatively be hinged to the inside or outside surface of the strips 20 (FIG. 9) to control separation. Hinged rings 30 can allow the strips 20 to rest next to each other in the relaxed state, but during the movement of the inner strip 20b, hinged rings 30 can each rotate and constrain the separation of the strips 20. Referring to FIG. 10, the strips 20 and separation control surfaces, ribs, or limb members 32 can also be molded as one piece. In this embodiment, the strips 20 and separation control surfaces, linking members or ribs 32 may be made from a molded plastic with the separation control surfaces 32 molded between the strips 20 with respective attachments to the strips 20 made by thin walled joints or hinges 32a. In the relaxed state, the strips 20 are next to each other, allowing for flexibility. As the inner strip 20b is pulled back, the separation control surfaces 32 rotate and control the amount of maximum separation of the strips 20, forcing them to bend and wrap around the object with the added stiffness created by the strip separation.

The grasping force of the adaptive gripper 14 can be controlled by stiffness of the strips 20 and strength of the outside tube 18, as a function of at least its material, that controls the separation of the strips 20 during actuation. The grippers 14 can have spring steel for the outside 20a and inside 20b strips. The stiffness of the strips 20 can be determined by the width, thickness, and length of the strips 20.

In an example embodiment, the outside tube 18 may be adaptive (e.g., in stiffness by physical property adjustment) such that the performance of the finger 16 can be modified in real-time, which may be done to change the grasping force to account for such issues as environmental temperature or type of object to be grasped, or for any other purpose based on the application to which the adaptive gripper 14 is to be applied.

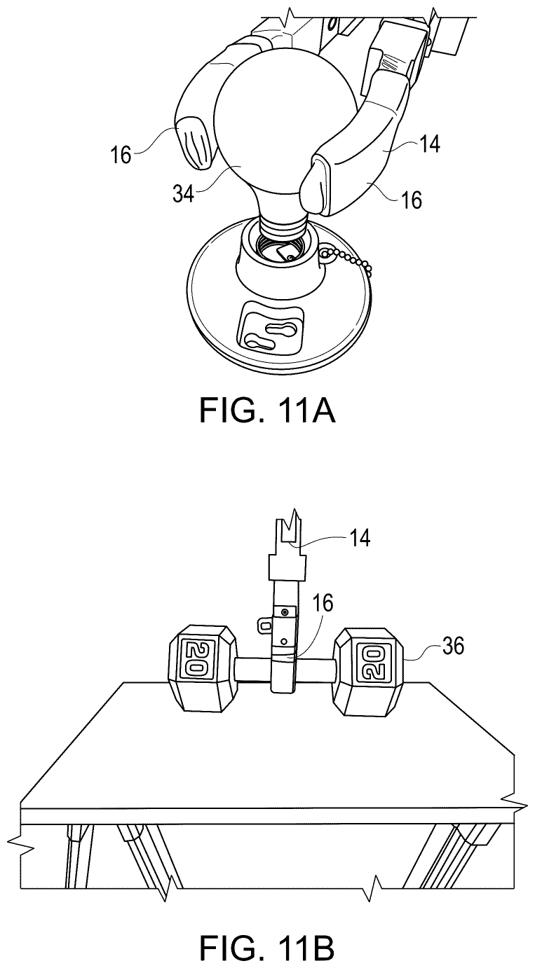

The adaptive gripper 14 can operate by distributing a load and wrapping around a target object, but the adaptive gripper 14 does not need to wrap completely to be effective as shown in FIG. 11A in the context of gripping a lightbulb 34. Such a grasp may be referred to herein as a pincer grip/grasp. Thus, a single embodiment of the adaptive gripper 14 may be employed to handle multiple different types of tasks, including those for which a pincer grip/grasp is all that is needed, such as picking up a popcorn kernel.

An example embodiment of a gripper finger 16 may be constructed from normally straight spring members, elements or beams formed of flat bands, straps or strips 20 having a rectangular cross section, and can be about 3.5 inches long, which emulates a typical length of a human finger. The width of the strips 20 can be of any size, but some common widths are 0.25, 0.5 and 1.0 inches. In some embodiments, the thickness of the spring steel strips 20 may be 0.010 to 0.030 inches. The width W to thickness T ratios W:T of spring steel strips 20 can often be in the 25:1 to 100:1 range. The outside strip 20a can be constructed with a thicker material and the inside strip 20b thinner. This can provide both stiffness and flexibility with the inside strip 20b wrapping around the object and the outside strip 20a providing stiffness and grasping power. The small thickness of the strips 20 allows the strips 20 to bend easily while the relatively large widths can provide the strips 20 with high strength, that can include longitudinal tension and compression. FIG. 11B shows an embodiment of an adaptive gripper 14 with two fingers 16 made from 1 inch wide stainless steel strips 20 that are gentle enough to change a 100 watt light bulb or handle an egg with a force of less than 0.1 lbs., and strong enough to lift a 20 pound weight 36. Embodiments of strips 20 having a rectangular cross-section can each have an area moment of inertia I=bh³/12 that enables cooperative operation of tension and compression, allowing one or both of the strips 20 to be pulled back or rearwardly in tension, or pushed forwardly in compression, while still being able to bend or flex.

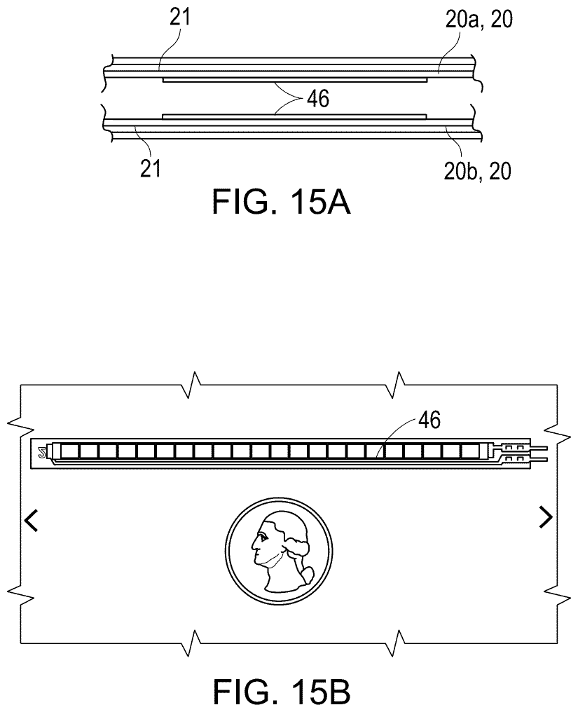

The strip 20 thickness can be designed to allow the strips 20 to flex but not thick enough that it would overstress the strip 20 and lead to limited life. Consequently, for the flex required to grab a typical object, spring steel strips 20 in some embodiments can have a thickness of 0.030 inches or less. To enhance the stiffness of the finger 16 and yet maintain infinite life, multiple strips or substrips 21 can be layered to form the outside 20a and inside strips 20b (FIG. 15A). The layering can allow for the use of thin strips 21 for infinite life, but the multiple strips 21 composing one or both of the inner strip 20b and the outer strip 20a can increase the stiffness and grasping power of the finger 16. It should be understood that dimensions of the inner 20b and outer strips 20a, or substrips 21 composing the same, may be different if made of materials other than steel, such as other metals for example aluminum, or polymers, textiles or composite materials.

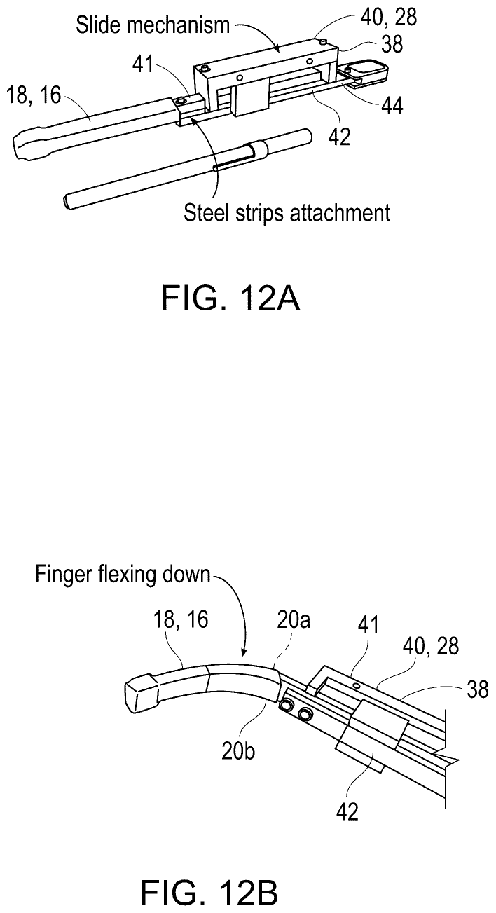

The adaptive robotic gripper 14 can be configured in a variety of configurations, including two, three, and five finger 16 configurations. Each individual finger 16 may be designed as a module with an outside 20a and inside 20b strip connected to a slide module, mechanical slider, or slide mechanism module 38, as illustrated in FIGS. 12A and 12B. The slide mechanism 38 can have a housing or frame 40 forming a base 28 to which the outer strip 20a can be fixed by a bar 41. The inner strip 20b can be slidably or moveably attached to the slide mechanism 38 and can be attached to a sliding or moving member or bar 42 that moves or slides relative to slide mechanism 38 for retracting or extending inner strip 20b relative to outer strip 20a. An outside tube 18 can control the maximum separation of the strips 20. Each finger 16 of such an embodiment can be actuated by an individual pneumatic, electrical, or other form of actuator known in the art. FIG. 12B shows the finger module flexing the finger 16 down or downwardly.

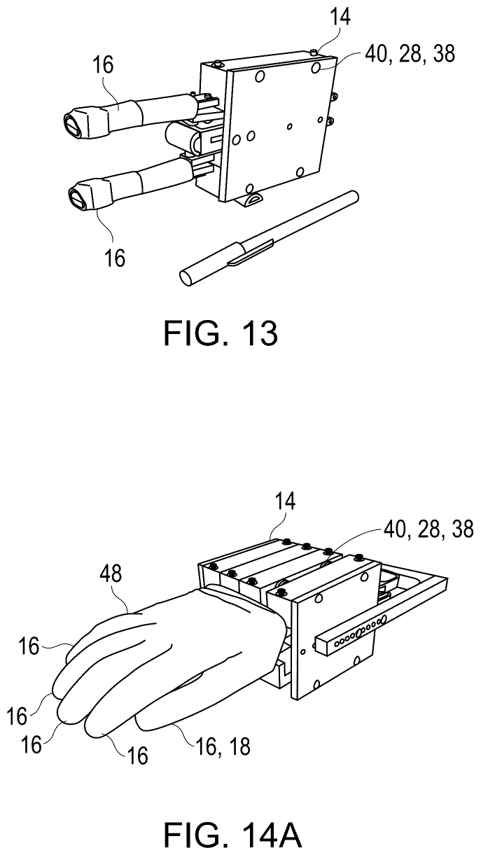

FIG. 13 shows a gripper 14 with a two finger 16 configuration, and FIGS. 14A-14C show a five finger 16 configuration within a glove 48, with one finger 16 being positioned to serve as an opposable thumb, forming a robotic glove or hand similar to a human hand. The configuration of the adaptive gripper 14 can be selectable by tasks that it is designed to accomplish. In some embodiments, the gripper 14 can be a prosthesis or prosthetic hand, and can be mounted to a user such as on the arm or shoulder (when including a prosthetic arm), and controlled by the user.

The adaptive gripper 14 can be scaled to different sizes. There can be variations in the finger diameter and length. The size of the strips 20, outside tubing 18, and mechanical slider 38 can be sized, for example, to create a finger 16 that is about 0.125 to 4.0 inches in diameter, and in some embodiments, about ¼ inches to 6 inches wide. The length of the finger, for example, can vary from about 1.0 to 24.0 inches, or even up to about 36 inches (3 feet). The finger size may be scaled to meet the loading demands of the objects that it is tasked to maneuver. The typical finger size may be similar to a human finger that is 0.5 inches in diameter and 3.5 inches long but much larger or much smaller grippers 14 can also be made as needed for the task.

The adaptive robotic gripper 14 can use fluid or compressed air to power the gripper 14, and can be precisely controlled with electrical actuation. Other forms of actuation may also be employed. The steel strips 20 in some embodiments, can provide a larger grasping force than a comparably sized prior art soft gripper. An example advantage of the adaptive robotic gripper 14 is that it is flexible like a soft gripper but has a larger load carrying capability similar to a rigid gripper. Before the adaptive gripper 14 is actuated, the fingers 16 can be very flexible in the relaxed state and can easily conform to the object that it is manipulating. Upon actuation, the fingers 16 of the adaptive gripper 14 can wrap around the object and become rigid, allowing the gripper 14 to impart a large grasping force on the object and maneuver it.

Embodiments of the adaptive robotic gripper 14 and fingers 16 can behave similar to a human hand and fingers but is simple in design and actuation. The pair of elongate strips 20 can allow the fingers 16 of the gripper 14 to wrap uniformly around the object with no high pressure points. The actuation of the adaptive gripper 14 can be accomplished with strips 20 that can sustain a large grasping force because of their large cross section, for example rectangular. The inner strip 20b in the adaptive gripper 14 can have a simple path that is determined by the outside tube 18 that constrains outward movement of at least one of the inner 20b or outer 20a strips. The inner 20b and outer 20a strips may be designed for infinite life as a function of dimensions, materials, operating parameters, or combination thereof. Embodiment of the adaptive fingers 16 have been cycle tested over 500,000 cycles.

The fingers 16 of the adaptive gripper 14 can have multi-Degrees of Freedom but utilize a simple mechanical structure. The adaptive gripper 14 in some embodiments use only one actuator 27 (FIG. 5) to power a finger 16. The flexibility of the fingers 16 of the gripper 14 allows it to adapt easily to the object it is grabbing. Control feedback of the adaptable gripper 14 can be possible by having both position and force feedback from each finger 16 to a control system. In an example embodiment, the slide module 38 used to push and pull the inner strip 20b of the finger 16 to create motion in the finger 16 can travel a total distance of approximately 0.625 inches for the adaptive gripper 14. A force sensor or transducer 44 (FIG. 12A) can be mounted in line with the slide module 38 to record the force required to move the finger 16 and grab an object. The position of the finger 16 can be calculated by using two flex sensors 46 that are mounted inside the finger 16 and attached to the outer 20a and inner 20b strip (FIG. 15A). FIG. 15B shows an example of a flex sensor 46 that can be used inside a glove to measure finger bending and position. The adaptive finger 16 can be very stiff in the direction ninety degrees to its plane of motion due to the relatively large width of strips 20, so the flex sensor 46 can be used to determine the location of finger 16 in the plane of motion. The combination of a force transducer 44 and flex sensor 46 in each finger 16 can allow for control feedback of the adaptive gripper 14. Alternative commercially available or custom designed sensors may be employed. In some embodiments, the outer 20a and/or inner 20b strips can be each formed of multiple or more than one deformable element, member or strip 21 assembled together, onto each other and/or side by side.

Embodiments of the adaptive gripper 14 can step the fingers 16 through a motion and stop at any point. The fingers 16 can be each actuated by a precision electrical actuator 27 that allows the fingers 16 of the gripper 14 to be stopped and held at any position between the start and end points of the finger trajectory. The actuator 27 can operate with a worm or screw drive that can automatically lock when the actuator 27 is powered off so that the fingers 16 will lock onto the object or railing and not let go. An emergency release mechanism can be incorporated into the gripper 14 that will unlock the fingers 16 from their grasp if the actuators 27 unexpectedly fail or lose power. In an example embodiment, electric motors and actuators 27 that drive the fingers 16 can be located in a palm of the gripper 14 to minimize the length of the gripper 14. Control feedback of the gripper 14 may be accomplished with a force sensor 44 and flex sensors 46 inside each of the fingers 16. The adaptive gripper 14 can also be equipped with haptic feedback and interfaces, which can include a haptic glove integrated into the gripper 14, or a remote haptic glove.

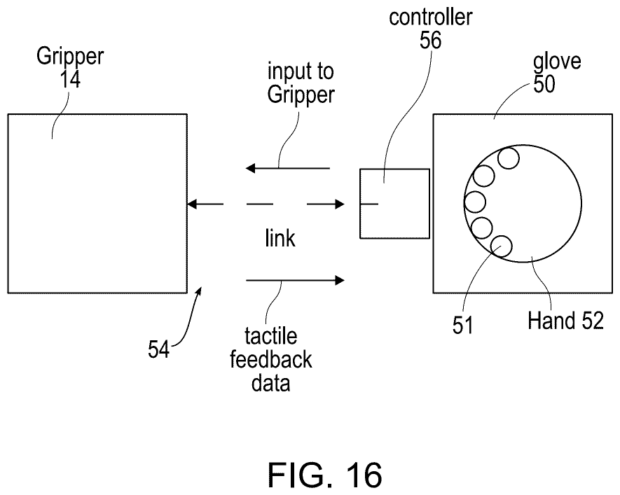

Referring to FIG. 16, the adaptive gripper 14 may also be integrated into an exoskeleton glove 50 that acts as an assistive device that can augment human strength and endurance, provide directed motion for use in rehabilitation, provide haptic feedback, or be used in other applications. For example, an embodiment of the glove 50 may be designed with the fingers 16 of the adaptive gripper 14 as an inside layer of the glove 50. A human wearer's hand 52 rests on top of the adaptive fingers 16, and control of each adaptive gripper finger 16 can be done by the fingers of the human hand pushing downward or upward on respective sensors 51 near the end of the adaptive finger 16. The grabbing and holding of the object may be performed by the adaptive gripper fingers 16, and no loads are exerted on the fingers of the human hand. An arm of the person wearing the device can support the weight of the glove 50 and payload, and if the payload is lifted, the fingers of the person would not experience any loading. Tasks that require large and/or repetitive grabbing loads can be alleviated by the exoskeleton glove 50 employing an embodiment of the adaptive gripper 14. In some embodiments, the gripper 14 can be considered an exoskeleton hand or part of an exoskeleton hand or glove. FIG. 16 is a schematic drawing showing an embodiment of an adaptive gripper 14 having a data link 54 connecting to a controller 56 and an interface glove 50 for the user's hand. The data link 54 can convey input data to the gripper 14 from the glove 50 and controller 56, and tactile feedback data from the gripper 14 to the controller 56 and glove 50. In other embodiments, the glove 50 can be remotely positioned from the gripper 14 for remote operation. In some embodiments, the gripper 14 can be remotely controlled by a controller 56 that has operational controls which are not haptic.

Embodiments of the adaptive gripper 14 can generate a large grasping force due to the second, inner or lower band, strip or strap 20b, which can be pulled back with a large force. The adaptive gripper 14 can utilize strips or straps 20 with a large cross section and simple path that can generate a very high grasping force compared to standard cable actuated robotic grippers.

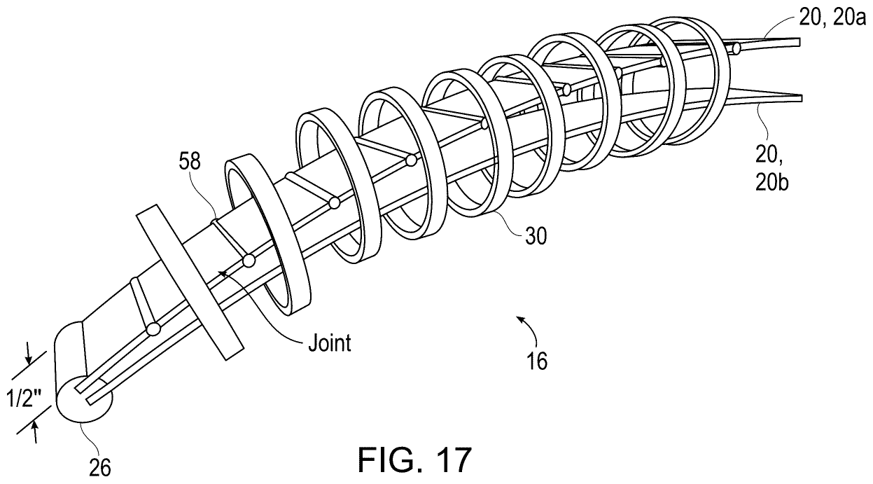

In the embodiment shown in FIG. 17, the adaptive gripper 14 can utilize a jointed top outer member, element, band, strap or strip 20a, in combination with the bottom inner 20b strip. The jointed top outer member can provide more flexibility and a lower pull force of the lower inner strip 20b to curl the finger 16. The lower strip 20b can be used to curl the finger 16 and produce a large grasping force. The rings 30 around the jointed member 20a and lower strap 20b can constrain and set the maximum separation distance and form the final finger configuration. The strip driven finger 16 can see a dramatic increase in both grasping force and longevity. The jointed robotic finger 16 with the bottom strip 20b can be extended out or curled in with the bottom strip 20b pushed out and pulled in, respectively. The adaptive robotic gripper 14 can have one bottom normally straight or flat flexible leaf spring member strip or strap 20b for both motions.

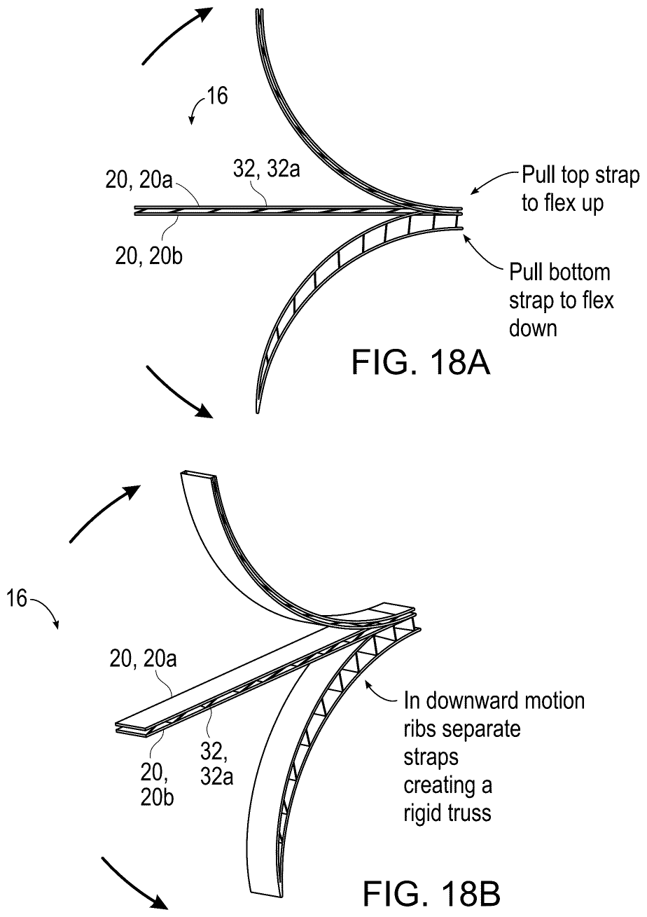

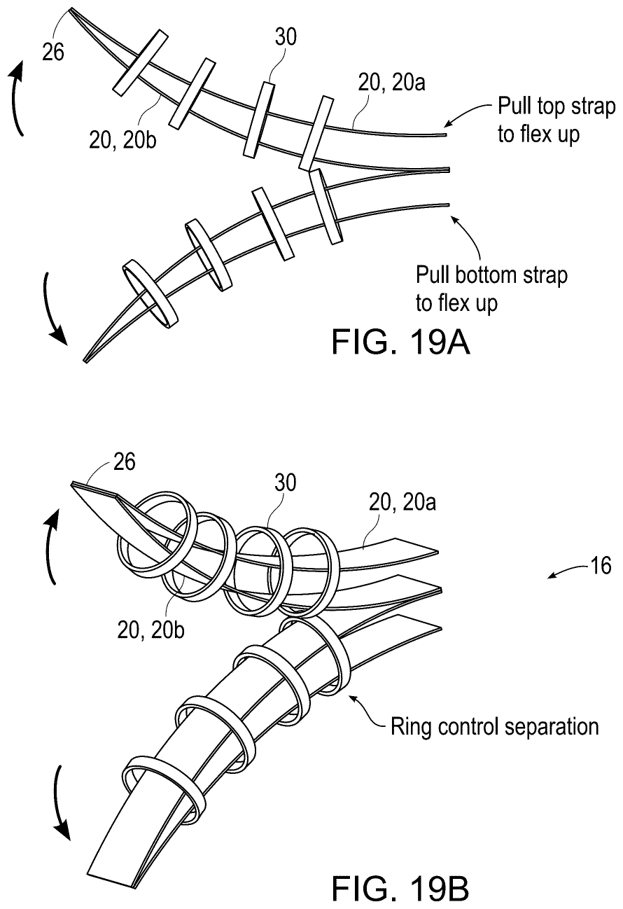

Unique features of embodiments of the adaptive gripper can include the following:
1. The fingers 16 of the adaptive gripper 14 can be configured into a two, three, four, five or other multiple finger configurations that best meet the task.
2. The size of the adaptive gripper 14 can be scaled to the task. In one case the gripper 14 can be miniaturized with fingers 16 being about ¼ inch wide and about 1 inch long to pick up a popcorn seed, or it can be sized to pick up a refrigerator of several hundred pounds, for example, with fingers 16 being about 6 inches wide and about 3 feet long.
3. In the unactuated state the fingers 16 of the gripper 14 can be flexible. When it engages the object in the unactuated state it can flex around the object and not damage it.
4. In the actuated state, the fingers 16 of the gripper 14 can become rigid with the outer or top 20a and inner or bottom 20b strip or strap forming a truss. In one embodiment, the top 20a and bottom 20b strips can be connected by internal ribs or linking members 32 that move with the strips as shown in FIGS. 18A and 18B. The ribs 32 can be connected to the strips 20 with joints 32a that allow the strips 20 to move relative to the ribs 32. As shown, when the top strip 20a is pulled or retracted or the bottom strip 20b extended, the strips 20 are flexed up, the strips 20 being kept together, and when the bottom strip 20b is pulled or retracted, the strips 20 are flexed down, the strips 20 being separated and distance constrained by the ribs 32 and cause a rigid truss to form. This gives the gripper 14 a strong grasping force and a rigid hold on the object.
5. In the embodiment of FIGS. 19A and 19B, the top 20a and bottom 20b strips or straps can be surrounded by rings 30. The rings 30 can be a series of individual spaced rings 30 or comprised of a helical or coil spring that wraps around a length of gripper finger 16 and strips 20, and can be embedded in a surrounding tube 18. The rings 30 can control or constrain the maximum separation distance when the straps 20 are separating from each other during actuation. At least portions of the strips 20 can be forced against the inner surfaces of the rings 30 as the top 20a or bottom 20b strip is actuated causing the finger 16 to flex. The maximum separation of the strips 20 can be restrained by the rings 30, together forming a rigid truss with the top 20a and bottom 20b strips. The top strip 20a can be pulled or retracted to flex up or bottom strip 20b can be extended to flex up, and the bottom strip 20b can be pulled or retracted to flex down. Embodiments can have one or both strips 20a and 20b capable of being actuated.

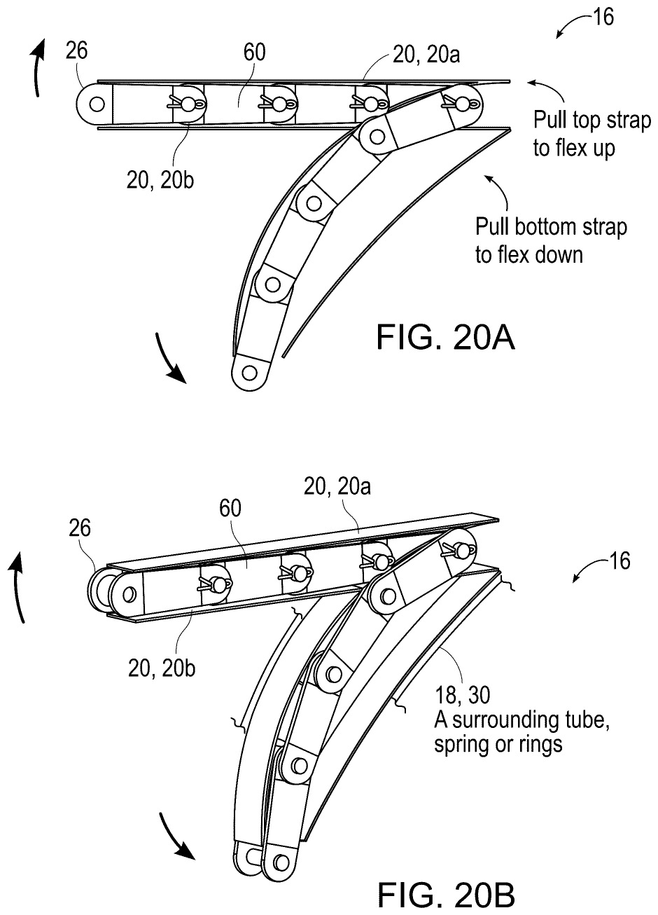

The embodiment of FIGS. 20A and 20B shows strips or straps 20 with a linked chain 60 separating the straps 20. The chain 60 serves to provide more lifting capability, especially in the transverse direction of the chain flexing. The strip separation can be controlled by surrounding the strips 20 and chain 60 with a spring, rings 30 or a tube 18 (woven steel tube) to control the separation distance of the strips 20. The strip 20b is able to exert more force (and more grasping force) since it is not constrained near the chain 60, but can move away from the chain 60 creating a larger moment on the finger joints. The top strip 20a can be pulled or retracted to flex up or the bottom strip 20b can be extended to flex up, and the bottom strip 20b can be pulled or retracted to flex down.

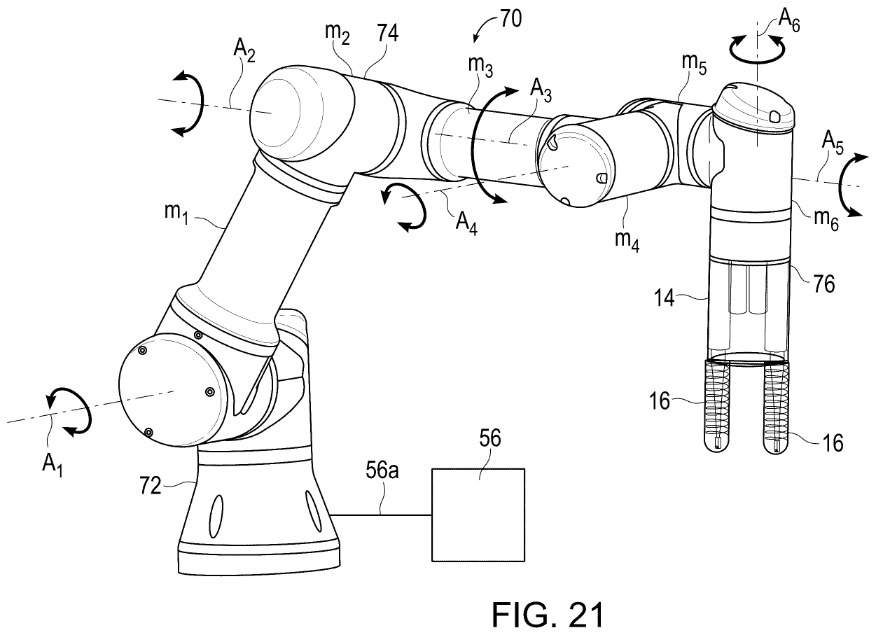

Referring to FIG. 21, embodiments of a robotic adaptive gripper 14 can have a base, housing, coupling, mount, bracket or adapter 76 that can be mounted, connected, coupled or attached to a robotic arm 74 of a robot 70. The robotic arm 74 can be rotatably mounted to an arm base 72, and can have six arm members M₁, M₂, M₃, M₄, M₅ and M₆ that are rotatable about six respective rotatable arm joints about respective rotatable axes A₁, A₂, A₃, A₄, A₅ and A₆ to provide movement of the gripper 14 with 6 degrees of freedom. The robotic arm 74 and/or the gripper 14 can be controlled by a controller 56 via line 56a, or by wireless communication. In the embodiment shown, the gripper 14 can have two fingers 16 positioned opposite to each other. It is understood that the robotic arm 74 can have other suitable configurations, depending on the task at hand.

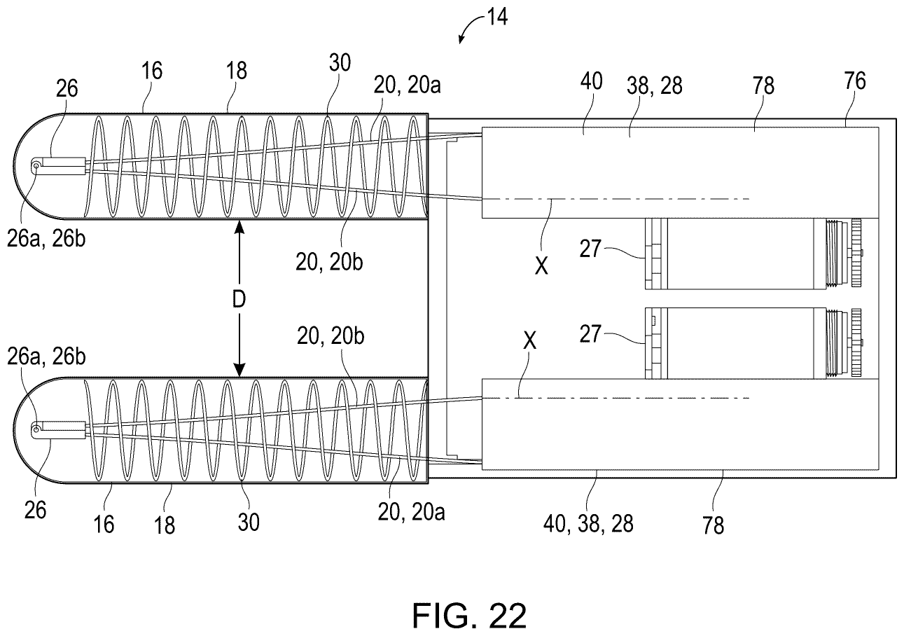

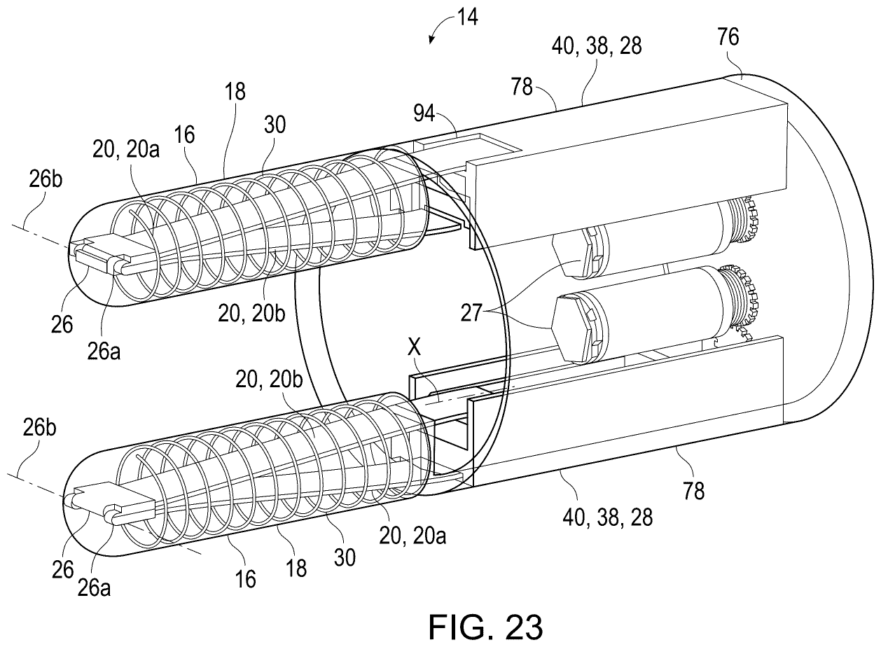

Referring to FIGS. 22 and 23, each actuating member or finger 16 can be part of a finger module or assembly 78 so that gripper 14 can have two finger modules 78 positioned within housing 76. Each finger module 78, can have a slide mechanism 38 with a housing or frame 40 to which a finger 16 is connected to and extends from. Each finger 16 can have a first flexible or deformable normally straight flat outer or outside, leaf spring, band, strip, strap, member or element 20a, and a second flexible or deformable normally straight flat inner or inside leaf spring, band, strip, strap, member or element 20b, that are connected together at the distal ends with a joint, connection, attachment point or coupling 26, that can have a hinge 26a extending along a lateral axis 26b. The outer 20a and inner 20b strips can be surrounded by a flexible movable or constraining member, material, skin, glove, tube or cover 18, which can also include a series of constraining members or rings 30 that can be formed by a helical or coil spring. The rings 30 can be separate or integrated into the tube 18. Each frame 40 can form a base 28 to which an outer or outside strip 20a can be fixed, secured or attached, and positioned on opposite outer sides of the gripper 14. Each slide mechanism 38 can include an actuator 27 for linearly actuating or moving a respective inner strip 20b for extension or retraction relative to the respective paired outer strip 20a. The inner strip 20b can act as a controlling, actuating or activating strip. The two finger modules 78 can be positioned within housing 76 in a spaced apart manner where the actuators 27 and inner strips 20b face each other, and the fingers 16 are spaced a suitable distance D apart from each other for grasping desired objects.

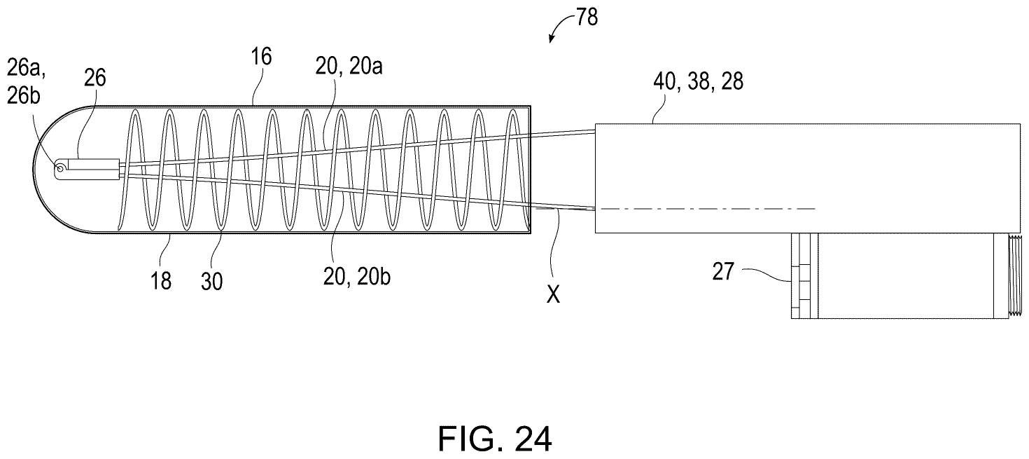

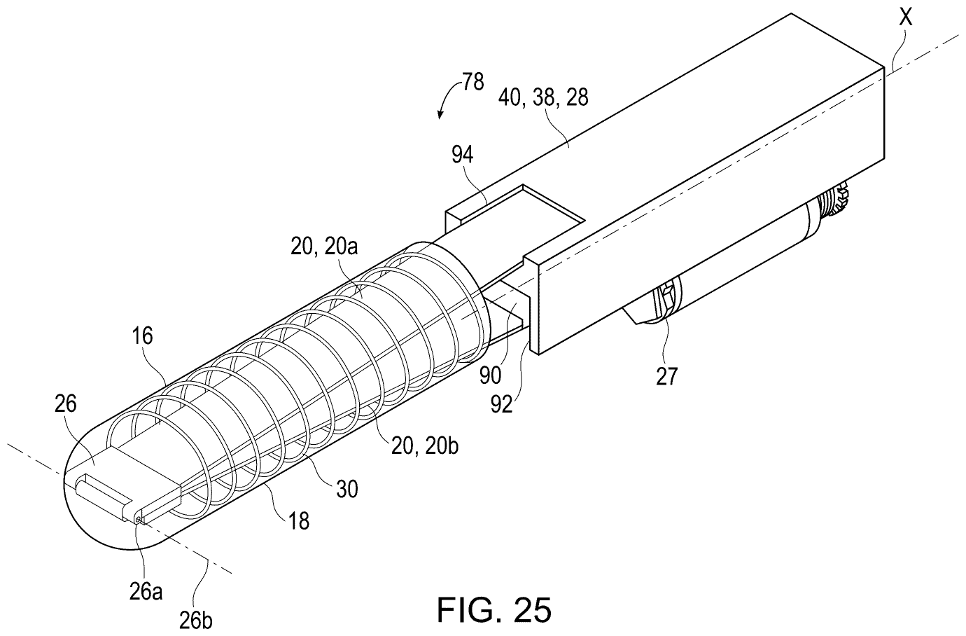

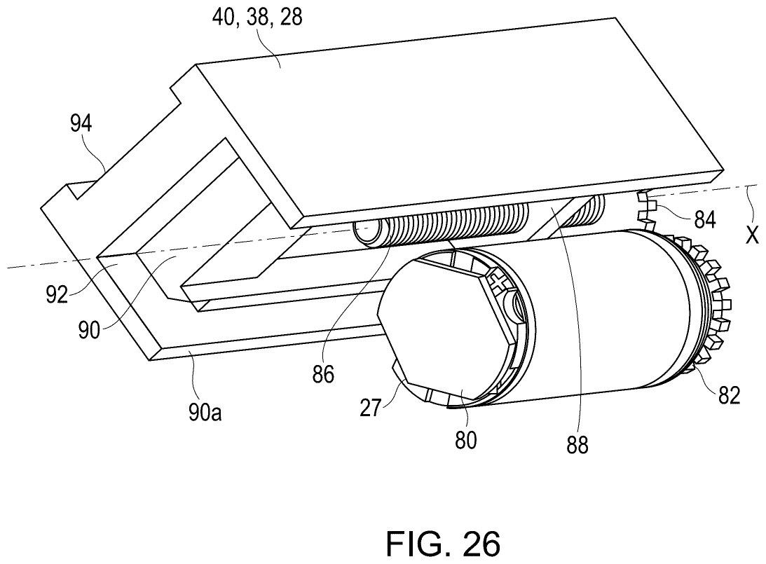

Referring to FIGS. 24-26, the outer 20a and inner 20b strips of each finger module 78 can extend from frame 40 in a spaced apart manner with the flat surfaces of strips 20a and 20b facing each other in alignment. With the distal ends of the outer 20a and the inner 20b strips being connected together by coupling 26, in the relaxed state, the strips 20a and 20b can form a generally triangular shape with the coupling 26 and the frame 40. At least portions of the outer 20a and inner 20b strips can be inwardly spaced apart from the tube 18 and rings 30. The frame 40 can have an outer recess or slot 94 into which the proximal end of the outer strip 20a can be inserted and secured to frame 40. In some embodiments, the proximal end of the outer strip 20a can be fixed to a bar 41 that is secured to frame 40 (FIGS. 12A and 12B). The proximal end of the inner strip 20b can be secured to a linear or movable slide 90 within a slot or recess 90a. In some embodiments, the proximal end of the inner strip 20b can be fixed to a bar 42 (FIGS. 12A and 12B) that is secured to slide 90. The slide 90 and inner strip 20b can slide or move along a longitudinal axis X that is spaced apart from the outer strip 20a. The outer strip 20a can angle distally towards longitudinal axis X in the distal direction. The actuator 27 can include a rotary motor 80 such as a stepper motor, that can be mounted to frame 40. The motor 80 can have a first or driving gear 82 for driving or rotating a second or driven gear 84. The driven gear 84 can be mounted to the end of a rotatable linear motion screw 86, that can rotate about longitudinal axis X or an axis parallel to axis X. The linear motion screw 86 can extend through a threaded nut 88 attached to slide 90 for linearly extending and retracting the slide 90 and inner strip 20b along longitudinal axis X relative to outer strip 20a. In some embodiments, the motor 80 and screw 86 can be replaced by an electric linear actuator, pneumatic cylinder or hydraulic cylinder.

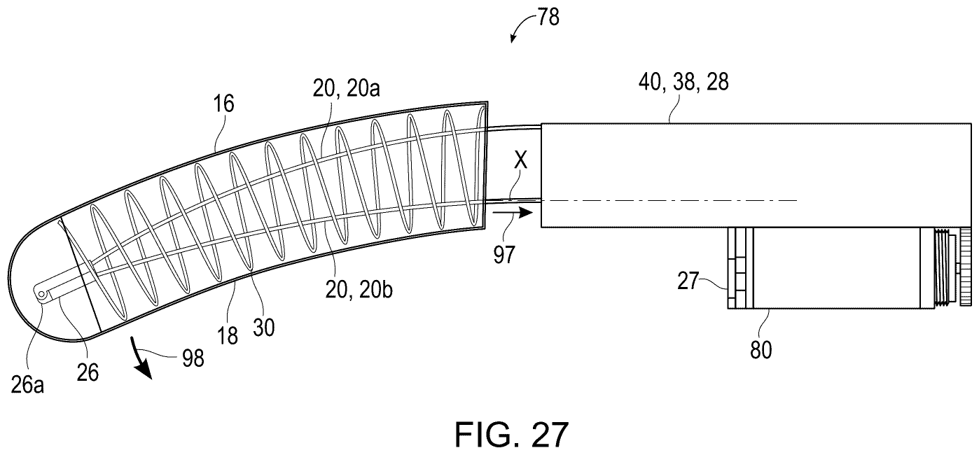

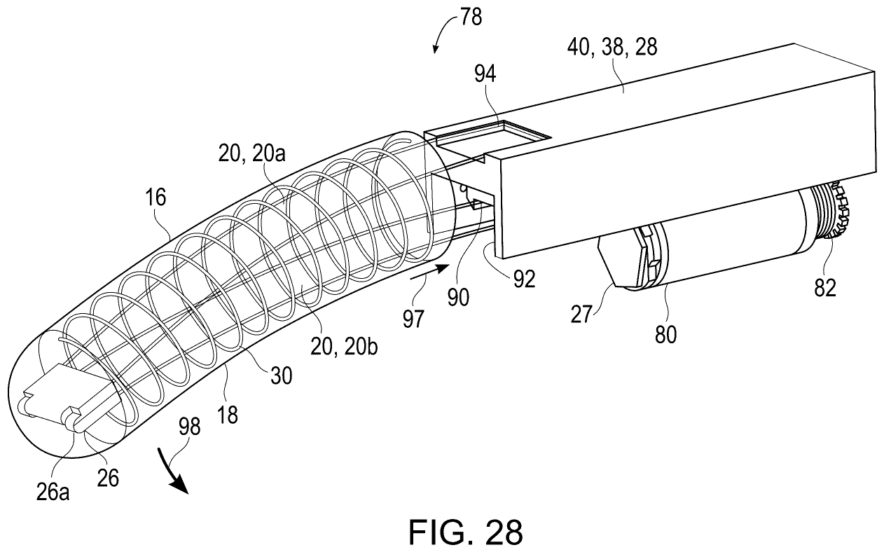

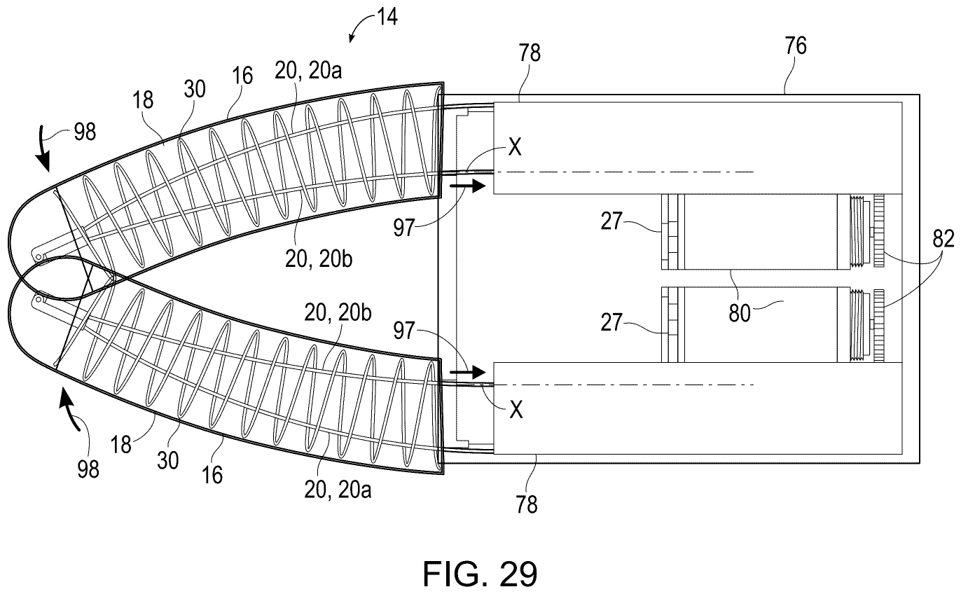

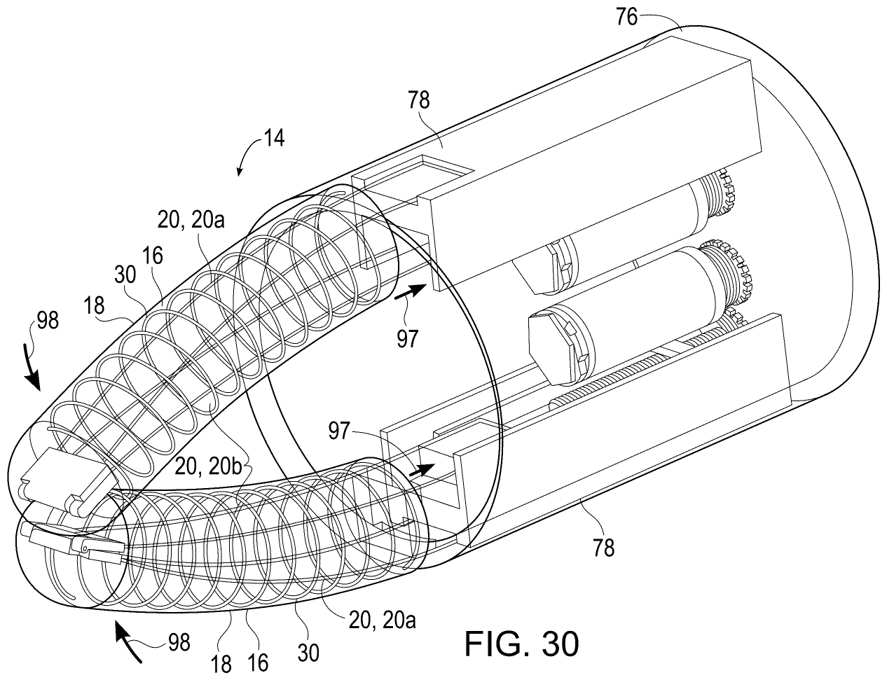

Referring to FIGS. 27 and 28, in use the finger 16 can be moved or bent in the direction of arrows 98 by retracting strip 20b relative to strip 20a and into frame 40, with actuator 27 and slide 90, linearly in the direction of arrows 97 along axis X. This shortens the length of strip 20b relative to strip 20a, thereby causing both strips 20a and 20b to bend in the direction of arrows 98, causing finger 16 to bend in that direction. In some embodiments a single finger module can be used on a robot 70 as a single finger end effector to perform certain tasks, for example insertion into holes or tubes, but in most embodiments, the end effector is a gripper 14 with at least two finger modules 78. Referring to FIGS. 29 and 30, when two finger modules 78 are positioned within housing 76 with inner strips 20b facing each other, retracting both strips 20b and slides 90 linearly in the direction of arrows 97 along respective axes X causes the two fingers 16 to bend towards each other in the direction of arrows 98 from opposite sides.

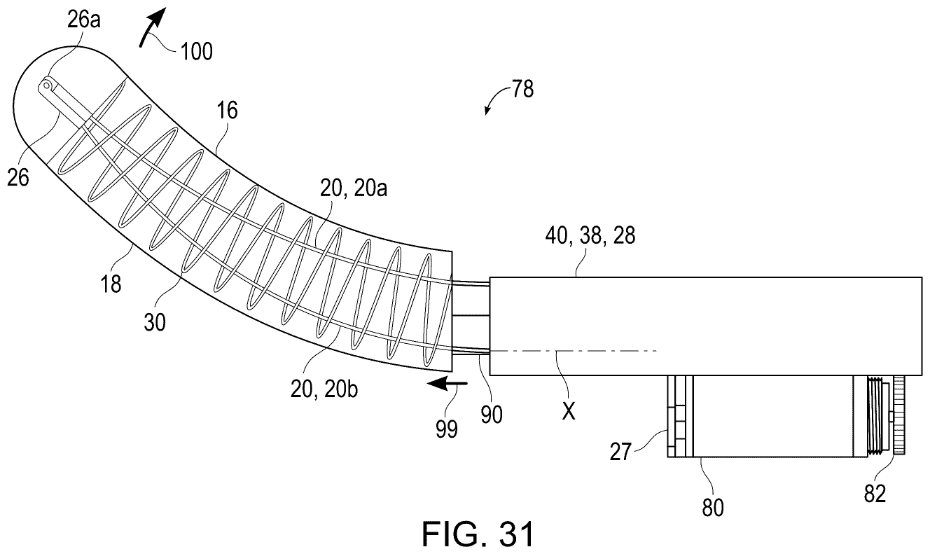

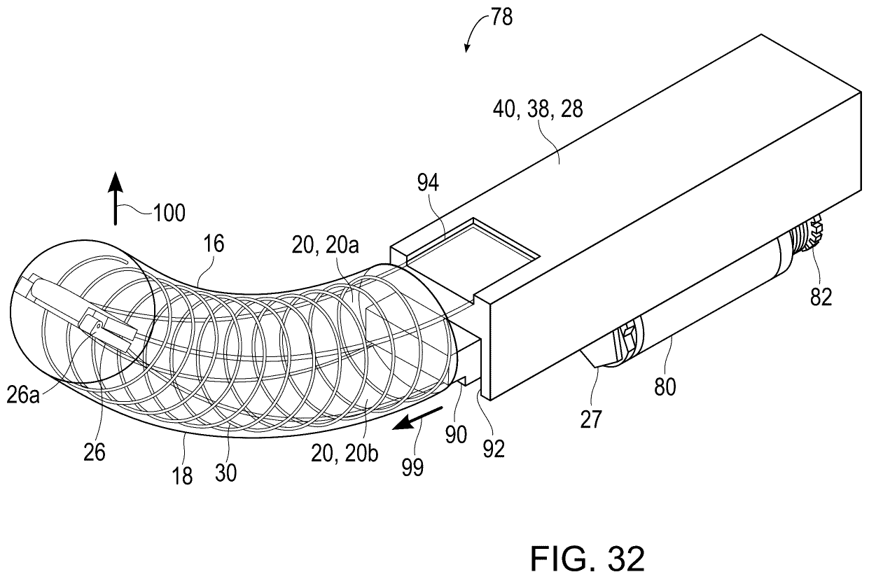

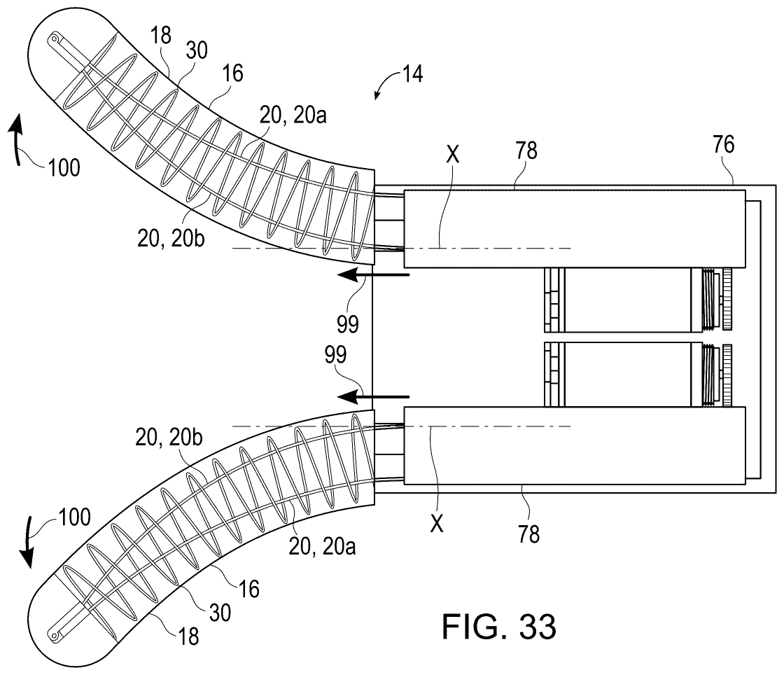

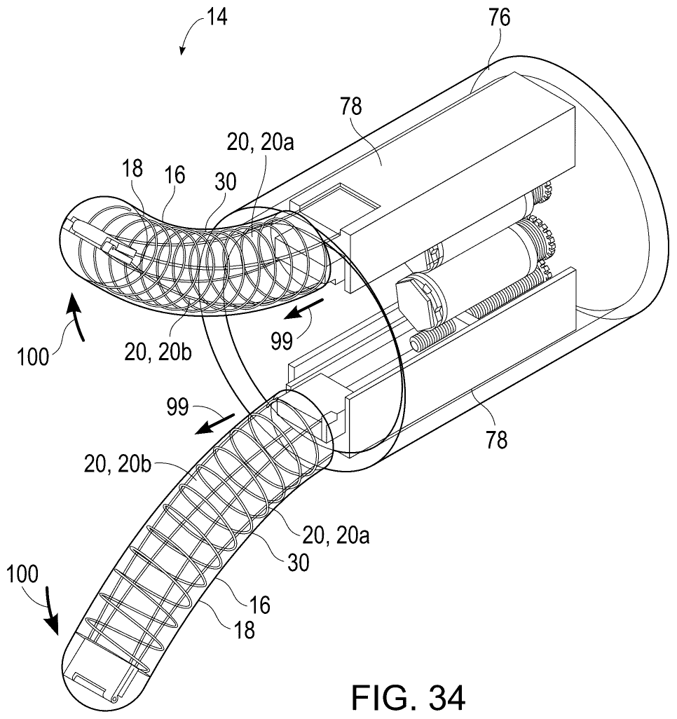

Referring to FIGS. 31 and 32, the finger 16 can be moved or bent in the opposite direction shown by arrows 100 by linearly extending slide 90 and strip 20b relative to strip 20a and frame 40, with actuator 27 in the direction of arrows 99 along axis X. This increases the length of the strip 20b relative to strip 20a, thereby causing both strips 20a and 20b to bend in the direction of arrows 100, causing finger 16 to bend in that direction. Referring to FIGS. 33 and 34, when the two finger modules 78 within housing 76 extend both inner strips 20b in the direction of arrows 99 along respective axes X, the two fingers 16 bend away from each other in the direction of arrows 100 in opposite directions. This can be helpful to spread the fingers 16 apart from each other if the object to be grasped is larger than the relaxed distance D between the fingers 16 (FIG. 22).

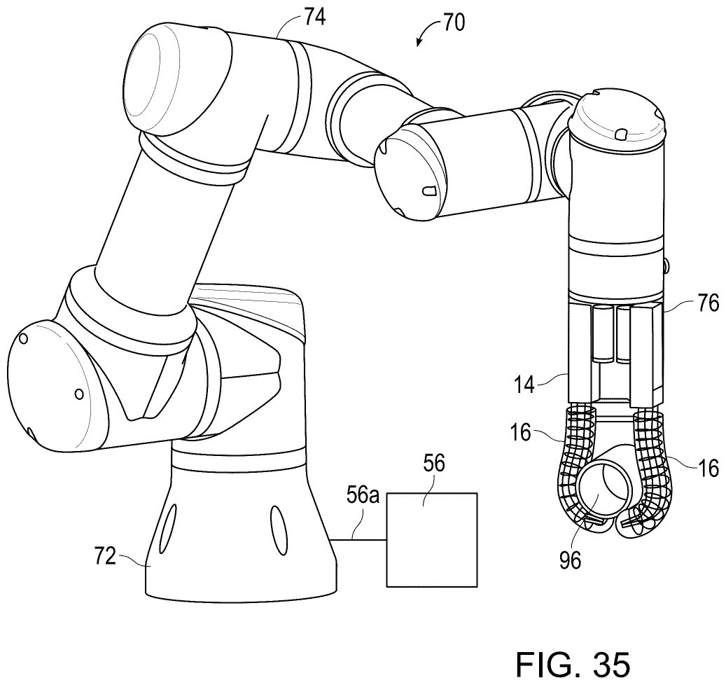

Referring to FIG. 35, the robotic arm 74 and robotic gripper 14 of robot 70 can be controlled by a controller 56 to be maneuvered, positioned and operated to grasp an object 96, for example a cylindrical object. In some embodiments, the controller 56 can be in communication with hand controls operated by the user, which can include a haptic hand controller in a master—slave arrangement. The positioning of the gripper 14 for grasping the object 96 can be close but does not need to be precise, since the inherent flexibility of the finger 16 of the gripper 14 can adjust or adapt to a certain amount of misalignment.

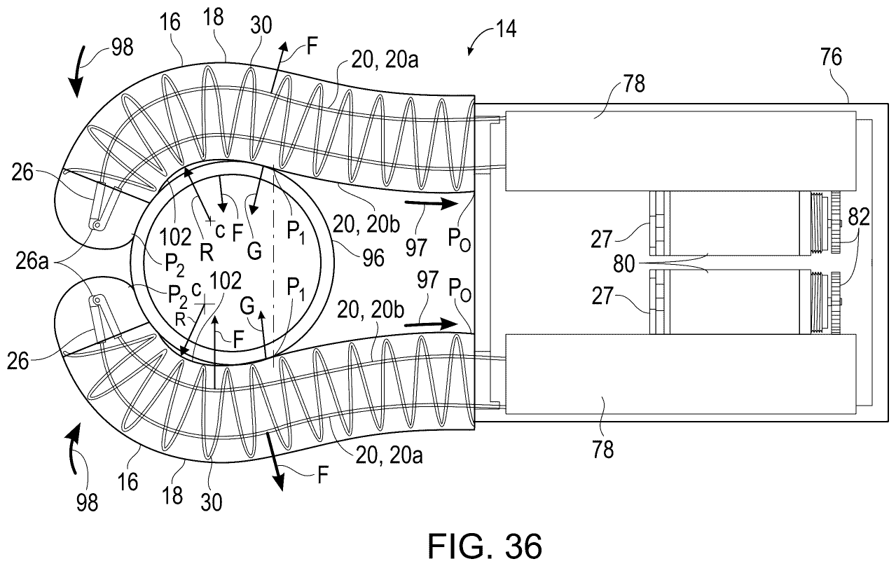

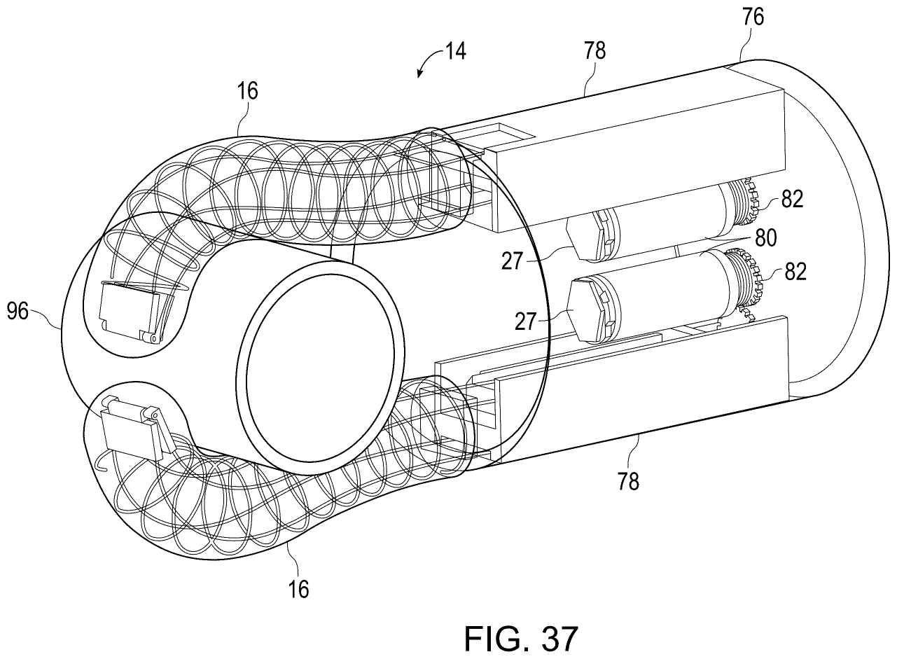

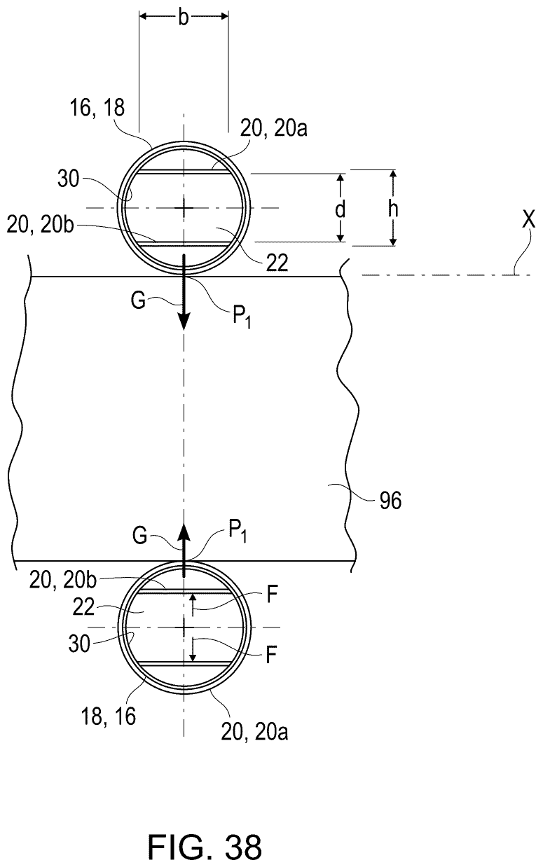

Referring to FIGS. 36-38, in view that the diameter or width of the object 96 is shown to be larger than the distance D (FIG. 22) between the fingers 16 when in the relaxed state, the fingers 16 can be operated to initially bend outwardly in the direction of arrows 100 as seen in FIGS. 33 and 34, by extending the inner strips 20b in the direction of arrows 99 along respective axes X in compression in order to spread the fingers 16 apart around object 96. The fingers 16 are then operated to bend inwardly around object 96 in the direction of arrows 98 by retracting inner strips 20b in tension in the direction of arrows 97 along respective axes X. As the fingers 16 move inwardly toward each other, the inner surfaces of each finger 16 contacts object 96 at a first or proximal contact point P₁ and distal portions of each finger 16 continue to wrap around the object 96, terminating contact with the object 96 at a second or distal contact point P₂. This can distribute the gripping force G of the fingers 16 evenly around object 96 between contact points P₁ and P₂. The degree or amount of inward curvature of the fingers 16 and strips 20 between contact point P₁ and contact point P₂ near or at the distal end of the finger 16 and strips 20a and 20b, can be greater than the inward curvature at the proximal end of the strips 20a and 20b between proximal point P₀ and the contact point P₁. There is no inward curvature between points P₀ and P₁ in the embodiment of FIG. 36 since object 96 is wider than distance D, while there is an inward curvature having a radius R extending from a point C between fingers 16 for each finger 16 between points P₁ and P₂. If the object 96 is smaller than the distance D between the two fingers 16, there can be some inward curvature between points P₀ and P₁, but such curvature will have a larger radius than radius R, and therefore have a smaller or lesser degree or amount of inward curvature. The proximal contact point P₁ can act as a pivot point around which each finger 16 and inner strip 20b bends around the object 96 and initiates the region of greater curvature for grasping the object 96. For some objects, the proximal contact point P₁ can move or adjust slightly as the inner strips 20b are further retracted. As the fingers 16 bend inwardly towards each other around object 96 with the retraction and shortening of the inner strips 20b relative to the outer strips 20a, the outer 20a and inner 20b strips in each finger 16 separate from each other with portions contacting the inner surfaces or diameters of the rings 30 and/or tube 18. The hinges 26a at the distal ends of strips 20a and 20b can facilitate the spreading of strips 20a and 20b apart. The outer 20a and the inner 20b strips in each finger 16 move in opposite directions and at least portions thereof can exert opposing forces F against the inner surfaces of the rings 30 and/or tube 18, engaging or locking against such inner surfaces. This locking of at least portions of the strips 20a and 20b against the inner surfaces of the rings 30 and/or tube 18 of each finger 16 can quickly form a stiff or rigid truss like structure which causes the finger 16 to become rigid. As a result, the fingers 16 can initially be flexible fingers 16 while in a relaxed state since the outer 20a an inner 20b strips are bendable or flexible across the flat surfaces, and then transform into strong stiff or rigid fingers 16 when gripping an object 96. The truss like structure that is formed can be thought of as a generally rectangular truss that can be explained by the second moment of area (parallel axis theorem) equation:

Iₓ=bh³/12+Ad²
where Iₓ is the area moment of inertia parallel to the x-axis or parallel to the base b (width of strips 20a and 20b), h is the overall height, A is a constant, and d is the distance between strips 20a and 20b at a given time. As can be seen, the further apart the strips 20a and 20b separate, the stronger and more rigid the finger 16 becomes. In some instances when the fingers 16 are gripping an object 96 gently, the inner strips 20b can be retracted only enough to partially separate strips 20a and 20b, but not to fully engage the inner surfaces of rings 30 and/or tube 18. This can still partially increase stiffness of fingers 16 and can be suitable for gripping delicate objects such as strawberries 12, and can still be considered to form a truss like structure.

In some embodiments, the actuator can extend or retract the outer strip 20a. In other embodiments, each strip 20a and 20b can be actuated by a respective actuator 27. Some embodiments can have flexible members or strips 20 that are weak in compression, so that each member or strip 20a and 20b can be retracted in tension for finger actuation. Although some embodiments of gripper 14 have been shown with two fingers 16, other embodiments can have three, four or five fingers each with a respective actuator 27, and can have an opposable thumb. Although embodiments of strips 20a and 20b of been shown to be flat bands, strips or straps, with a rectangular cross-section having flat opposite faces or surfaces for bending easily around, over or relative to the flat surfaces, other cross-sections can be used for example round, curved or complex. In some embodiments, one or both of the strips 20 can be normally bent so that the finger 16 is in a normally bent position in the relaxed state, and can be actuated to straighten out and/or to further bend the finger 16.

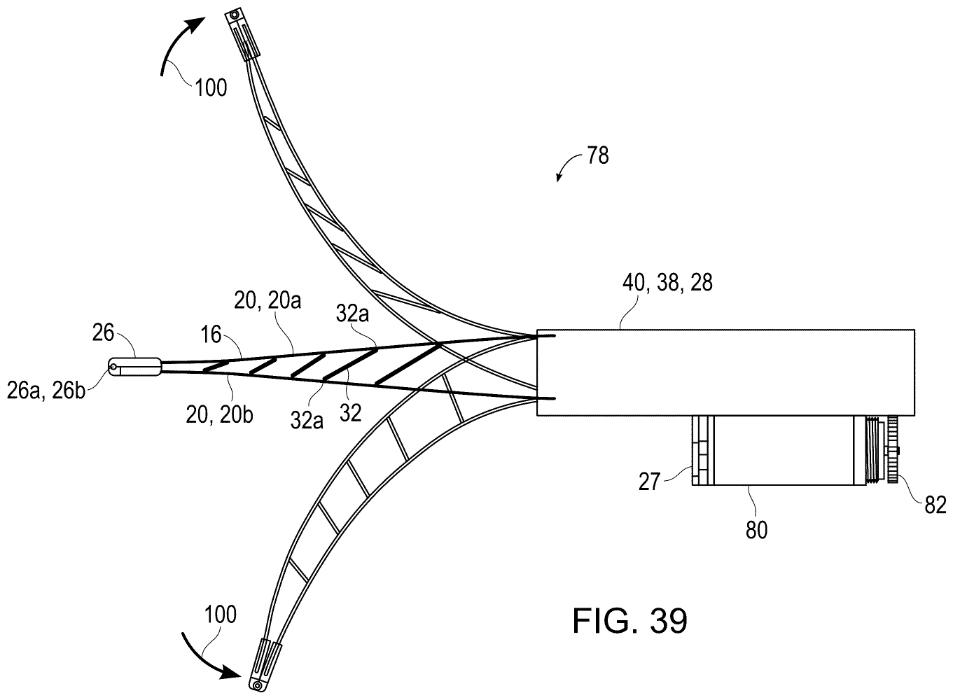

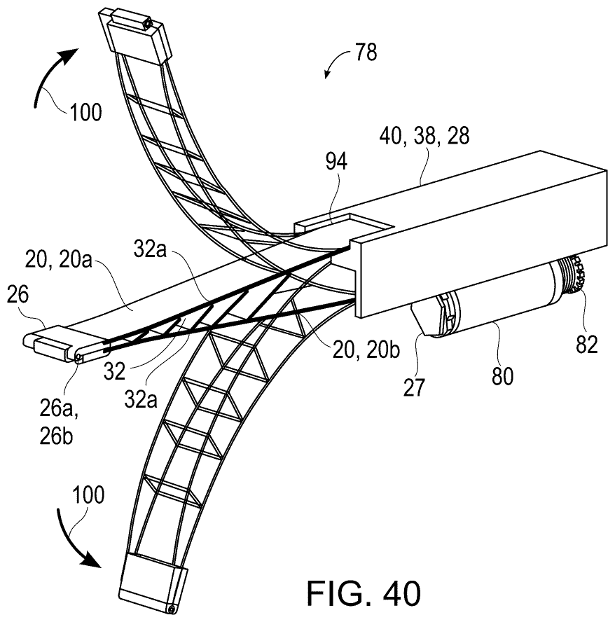

Referring to FIGS. 39 and 40, instead of having a constraining member or rings 30 and/or a tube 18 surrounding strips 20, finger module 78 can have outer and inner members, elements, strips, straps or bands 20a and 20b that are connected together by a series of ribs and or linking members 32 with rotating or movable hinges 32a. The ribs 32 can be larger or taller in height near or at the proximal end, and smaller or shorter in height near or at the distal end of strips 20. As the inner strip 20b is retracted and extended relative to the outer strip 20a the strips 20 bend and separate from each other but the separation is constrained or restricted by the height or the size of the ribs 32, as the ribs 32 rotate from a flatter or lower position, and move into a more upstanding or taller position.

While example embodiments have been particularly shown and described, it will be understood by those skilled in the art that various changes in form and details may be made therein without departing from the scope of the embodiments encompassed or contemplated herein. For example, features of the different embodiments can be omitted or combined together. The size of various components can vary depending upon the application at hand. Although terms such as upper, lower, top, bottom, inner and outer have been used, different orientations of the finger module components can occur. In some embodiments, the at least one moveable member or at least one constraining member can be omitted, and the first and second deformable elements or strips operated without it.

What is claimed is:

1. An end effector, comprising:
a first deformable element having a proximal end and a distal end;
a second deformable element having a proximal end and a distal end, the first and second deformable elements mechanically coupled at the respective distal ends;
at least one movable member for mechanically interacting with and increasing structural strength of at least one of the first and second deformable elements between the respective proximal ends and distal ends upon actuation of at least one of the first and second deformable elements, the first and second deformable elements each having an area moment of inertia that enables cooperative operation of tension and compression; and
an actuating arrangement to which at least one of the first and second deformable elements is coupled at the respective proximal end.

2. The end effector of claim 1 in which at least one of the first and second deformable elements are normally straight flexible spring members.

3. The end effector of claim 1 in which the end effector is a gripper, the first and second deformable elements and the at least one movable member, are included in a first finger of the gripper, the gripper further including at least a second finger that has at least a second set of the first and second deformable elements and the at least one moveable member, for gripping an object between the first finger and the at least a second finger.

4. The end effector of claim 1 in which the at least one movable member is at least one of a constraining member, chain, link, tube, coil spring, ring, glove and rib.

5. The end effector of claim 4 in which the at least one movable member constrains separation distance between the first and second deformable elements.

6. The end effector of claim 5 in which the at least one movable member comprises at least one constraining member encircling the first and second deformable elements.

7. The end effector of claim 5 in which the at least one movable member comprises at least one connecting member extending between the first and second deformable elements.

8. The end effector of claim 2 in which at least one of the first and second the deformable elements comprise a flat band having a rectangular cross-section.

9. The end effector of claim 8 in which at least one of the first and second deformable elements comprise a band formed of at least one of spring steel, aluminum, metal, polymer, textile and composites.

10. The end effector of claim 9 in which at least one of the deformable elements includes at least one hinge between the proximal and the distal ends.

11. The end effector of claim 9 in which the first and second deformable elements range from about ¼ inch to 6 inches wide, about 1 inch to 3 feet long, and about 0.010-0.030 inches thick.

12. The end effector of claim 1 in which the actuating arrangement comprises at least one actuator connected to at least one of the first and second deformable elements, for at least one of retracting and extending the first and second deformable elements relative to each other, to bend the first and second deformable elements and cause the first and second deformable elements to mechanically interact with the at least one movable member to form a truss like structure.

13. The end effector of claim 3 in which the first finger and at least a second finger are each connected to a respective first and at least a second actuator, the first and the at least a second actuator for at least one of retracting and extending the first and second deformable elements of the first finger and of the at least a second finger relative to each other, to bend the respective first and second deformable elements and cause the respective first and second deformable elements to mechanically interact with the respective at least one movable member to form a respective truss like structure and increase gripping strength between the first finger and the at least a second finger.

14. The end effector of claim 13 in which at least one finger is arranged to serve as an opposable thumb of at least one of a robotic hand, an exoskeleton glove and a prosthetic hand.

15. The end effector of claim 14 further comprising a robotic arm, the gripper being mounted to the robotic arm.

16. The end effector of claim 15 further comprising a controller for controlling at least one of the gripper and the robotic arm.

17. The end effector of claim 16 further comprising a sensor arrangement incorporated into the first finger and the at least a second finger for sensing at least one of bending, position and force effects of respective finger.

18. The end effector of claim 17 in which the gripper is controlled by a haptic interface, the haptic interface comprising a haptic glove for insertion of a user's hand.

19. The end effector of claim 15 which the end effector and the robotic arm comprises a robot.

20. An end effector, comprising:
a first deformable element having a proximal end and a distal end;
a second deformable element having a proximal end and a distal end, the first and second deformable elements mechanically coupled at the respective distal ends;
at least one constraining member for mechanically constraining separation distance between the first and second deformable elements between the respective proximal ends and distal ends, the first and second deformable elements each having an area moment of inertia that enables cooperative operation of tension and compression; and
an actuating arrangement to which at least one of the first and second deformable elements is coupled at the respective proximal end for at least one of retracting and extending the first and second deformable elements relative to each other, to bend the first and second deformable elements and cause the first and second deformable elements to mechanically interact with the at least one constraining member and form a truss like structure.

21. A method of operating an end effector, comprising:
providing a first deformable element having a proximal end and a distal end;
providing a second deformable element having a proximal end and a distal end, the first and second deformable elements mechanically coupled at the respective distal ends;
providing at least one movable member for mechanically interacting with and increasing structural strength of at least one of the first and second deformable elements between the respective proximal ends and distal ends upon actuation of at least one of the first and second deformable elements, the first and second deformable elements each having an area moment of inertia that enables cooperative operation of tension and compression;
providing an actuating arrangement to which at least one of the first and second deformable elements is coupled at the respective proximal end; and
actuating at least one of the first and second deformable elements with the actuating arrangement to at least one of retract and extend the first and second deformable elements relative to each other, to bend the first and second deformable elements.

22. The method of claim 21 in which at least one of the first and second deformable elements are normally straight flexible spring members.

23. The method of claim 21 in which the end effector is a gripper, the first and second deformable elements and the at least one movable member, are included in a first finger of the gripper, the gripper further including at least a second finger that has at least a second set of the first and second deformable elements and the at least one moveable member, for gripping an object between the first finger and the at least a second finger.

24. The method of claim 23 in which the at least one movable member is at least one of a constraining member, chain, link, tube, coil spring, ring, glove and rib.

25. The method of claim 24 in which the movable member constrains separation distance between the first and second deformable elements and forms a truss like structure, increasing gripping strength between the first finger and the at least a second finger.

26. The method of claim 25 further comprising gripping the object between the first finger and the at least a second finger, and further at least one of retracting and extending the first and second deformable elements of the first finger and the at least a second finger relative to each other, thereby causing the first finger and the at least a second finger to bend around a portion of the object, degree of curvature between a contact point of each finger on the object and the distal end of each finger being greater than degree of curvature between the proximal end of each finger and the respective contact point on the object.

27. The method of claim 26 further comprising operating the gripper with a robotic arm, the gripper being mounted to the robotic arm.

28. The method of claim 27 further comprising controlling at least one of the gripper and the robotic arm with the controller.

29. The method of claim 28 further comprising sensing at least one of bending, position and force effects of each finger with a sensor arrangement incorporated into the first finger and the at least a second finger.

30. The method of claim 29 further comprising controlling the gripper with a haptic interface comprising a haptic glove into which a user's hand is inserted.

31. The method of claim 23 in which the first finger and the at least a second finger are each connected to a respective first and at least a second actuator.
